(19) United States
(12) Patent Application Publication
(10) Pub. No.: US 2022/0232846 A1
(43) Pub. Date: Jul. 28, 2022

(54) Methods of Using Acid Whey

(71) Applicant: The Curators of the University of Missouri, Columbia, MO (US)

(72) Inventor: Kiruba Krishnaswamy, Columbia, MO (US)

(21) Appl. No.: 17/586,675

(22) Filed: Jan. 27, 2022

Related U.S. Application Data
(60) Provisional application No. 63/142,329, filed on Jan. 27, 2021.

(51) Int. Cl. A23C 21/08; A23C 21/06; A23C 1/04

(52) U.S. Cl. CPC A23C 21/08; A23C 1/04; A23C 21/06

(57) ABSTRACT

A method for forming an acid whey-based food product, the method comprising: (a) preparing a matrix suitable for spray drying, wherein the matrix is a homogenous mixture comprising acid whey and flour; and (b) spray drying the matrix to form a powder of dried matrix; thereby forming the acid whey-based food product that is a powder comprising particles, wherein each particle comprises homogeneous mixture of dried acid whey and flour.

### CROSS-REFERENCE TO RELATED APPLICATIONS

The present application is a non-provisional application claiming the benefit of 63/142,329, filed Jan. 27, 2021, which is incorporated herein by reference in its entirety.

### STATEMENT REGARDING FEDERALLY SPONSORED RESEARCH OR DEVELOPMENT

This invention was made with government support under MO-HAFE0003 awarded by the USDA. The government has certain rights in the invention.

### BACKGROUND OF INVENTION

### Acid Whey

According to the World Health Organization, undernutrition is the major cause of death amongst children under the age of five. Undernutrition is primarily because of poor diets that have low nutrient density. Inadequate intake of vitamins and minerals in diet, prevents the human body from synthesizing limited enzymes or hormones that are required for growth. As the infant grows older than six months, the necessity of these micronutrients and calories increases, and are not fulfilled with breast milk alone. Hence, for children older than six months, complementary foods are recommended along with breast milk to support physical and cognitive development. These complementary foods products are solid, semi solid and soft food that can be used to complement breast milk.

On the other hand, for improvement of food and nutrition security, it is critical to reduce food losses/waste. According to the Food Agriculture Organization (FAO), one third of the global food produced is wasted every year. This waste is a burden for the natural environment but can be upcycled for production of value-added food products. Acid whey from Greek yogurt manufacturing is one of the examples of a food byproduct that is generated in large quantities and is dumped into the surroundings, causing harm to land and water resources. However, various studies have reported that acid whey contains various macro-micronutrients, such as vitamins, fatty acids and polyphenols. It is also found that acid whey has the same probiotic properties as yogurt. Several studies have also reported that acid whey consists of lactoferrin which has been found to have clinical benefits in infants and toddlers that aid in their immunity. However, studies have reported that acid whey has a high amount of lactic acid and mineral content that make its processing challenging. Studies have found that neutralization of acid whey can ease its processing. Currently, a popular neutralization method involves food grade ammonium hydroxide, potassium hydroxide, sodium bicarbonate and other chemicals.

A need still exists for an improved method for transforming acid whey into a useful food products, including complementary food products.

### Titanium Dioxide as a Food Additive

The food-grade form of TiO₂ (E171) is used as a whitening pigment and anticaking agent in the food industry. Various food products like candy, icing, chewing gum, salad dressings, and confectionery items have been found to contain the highest amount of TiO₂. Daily exposure of humans to TiO₂ nanoparticles have been reported to be 1.1 mg/kg body weight/day in the UK and 2.2 mg/kg body weight/day in the US. Children were found to have a higher exposure to TiO₂ since they heavily consume the food products with the highest amounts of TiO₂. During supplementary feeding, infants could be exposed to TiO₂ through two possible routes: either from consuming commercially prepared infant food that contains TiO₂ or from consuming highly processed foods like candies, drinks and desserts containing TiO₂. Titania nanoparticles have been shown to be absorbed in animal and human studies. Titania particles were found postmortem human tissues of the liver, spleen, kidney, jejunum and in human placentas, which suggest that it is capable of crossing human placental membranes.

The use of TiO₂ as a food additive is currently under scrutiny due to its potential impacts on human health and the environment. Food-grade TiO₂ is broadly used in the food industry as food additives and are permitted by the US Food and Drug Administration and European Union as anticaking and coloring agents food products. The US Food and Drug Administration allows the use of TiO₂ in food if the weight of the amount used does not exceed 1% of the overall food weight. Currently the European Union (EU) allows the use of TiO₂ in foods with no specified limits as long good manufacturing practices are followed. However, in 2020, France banned the use of E171 as a food additive. Additionally, in May 2021, the European Food Safety Authority (EFSA) updated its safety assessment on TiO₂ E171 and concluded “E 171 can no longer be considered as safe when used as a food additive.”

Consumers are increasingly demanding titanium free food colorants and products. Since whiteness is an important food color property that influences consumers acceptance, food manufacturers and researchers are in quest to develop alternative food whitening to meet the rising demand for natural and functional ingredients. A need exists for an alternative to TiO₂ E171 as a food colorant.

### Increasing the Diversification of Grains

Agricultural diversification is essential to making agricultural food systems more sustainable and attaining food and nutritional security. Approximately 30,000 edible plant species are known, but only 30 of these known plants feed the world, and only a few are cultivated on a large scale. Global agricultural production currently focuses on cultivating few high-yielding staple grains—maize, wheat, rice, barley, and to a lesser extent, sorghum. This has resulted in a reduction in the biodiversity of agricultural cropping systems worldwide and a decline in the cultivation of traditional crops. Key strategies to securing a sustainable food system and nutrition security involve popularizing the production of underutilized crops, encouraging crop diversification, and prioritizing the dietary quality of food.

Globally, countries stand to benefit from producing underutilized grains. In some regions in Africa, like sub-Saharan Africa, where water is scarce, climate change is of great concern. Crops will need to survive on very fragile soils that will undergo severe fluctuations in temperatures and rainfall. Since underutilized grains adapt well to marginal and precarious environments, they can play a significant role in reducing the vulnerability of farming systems to climate change, maintain high yields, and producing crops with diverse quality attributes. Because most of these grains are grown in rural communities, they are an accessible means of adaptation for indigenous farmers, thereby providing income opportunities for these small farmers. Growing underutilized grains increases women's employment opportunities, thereby enhancing their social status. Along with their adaptation to adverse ecological conditions, some underutilized grains have significant levels of important micronutrient and have the potential for reversing the trend of micronutrient deficiencies (hidden hunger) in both developing and developed countries.

Although agricultural grasses (Poaceae family) that contain edible seeds can be grouped under cereals, there are still no clear classifications. Millets and sorghum have been commonly named pseudo cereals, seed grains, and underutilized grains. Millets and sorghums are well adapted to harsh weather conditions and can be grown in low agricultural potential environments. According to FAOSTAT [16], the United States, India, Nigeria, Mexico, and China are the largest producers of millets and sorghum globally. Millets and sorghum are underutilized seed grains in both the developed and developing world. In Africa and Asia, millet and sorghum grains are essential staple food crops for millions of people. In most developed countries, sorghum is primarily used as animal feed. These underutilized crops have been shown to adapt to a wide range of climate conditions and may be nutrient dense and offer better growth prospects in marginal production areas.

A need still exists for food applications utilizing diverse types of grains to drive agricultural diversification.

### SUMMARY OF INVENTION

One embodiment of the present invention is directed to method for forming an acid whey-based food product, the method comprising:
(a) preparing a matrix suitable for spray drying, wherein the matrix is a homogenous mixture comprising acid whey and flour; and
(b) spray drying the matrix to form a powder of dried matrix;
   thereby forming the acid whey-based food product.

Another embodiment of the present invention is directed to an acid whey-based food product that is a powder comprising particles, wherein each particle comprises homogeneous mixture of dried acid whey and flour.

### BRIEF DESCRIPTION OF THE DRAWINGS

FIG. 1 is a graph displaying the Essential Amino Acid profile of sorghum, finger millet, little millet, wheat, rice, and maize.

FIG. 2 A is a table showing the size distribution of grains of barnyard millet. FIG. 2 B is a table showing the size distribution of grains of finger millet. FIG. 2 C is a table showing the size distribution of grains of little millet. FIG. 2 D is a table showing the size distribution of grains of sorghum.

FIG. 3 A is standard calibration curve of gallic acid. FIG. 3 B is a graph showing the total phenol content of barnyard, finger, little millets and Sorghum in Gallic acid equivalent (GAE) in mg/g of the extract (the mean values not followed by the same letter are significantly different (Tukey's HSD, p<0.05). Data expressed in Mean±SD of n=4 replicates).

FIG. 4 is a graph showing the DPPH radical scavenging activity of barnyard, finger, little millets and sorghum (data expressed in Mean±SD of n=4 replicates).

FIG. 5 A is a standard calibration curve of MDA. FIG. 5 B is a graph showing TBARS in barnyard, finger, little millets and sorghum (Mean values not followed by the same letter are significantly different (Tukey's HSD, p<0.05). Data expressed in Mean±SD of n=4 replicates).

FIG. 6 is a process flow diagram for spray drying an acid whey-millet matrix.

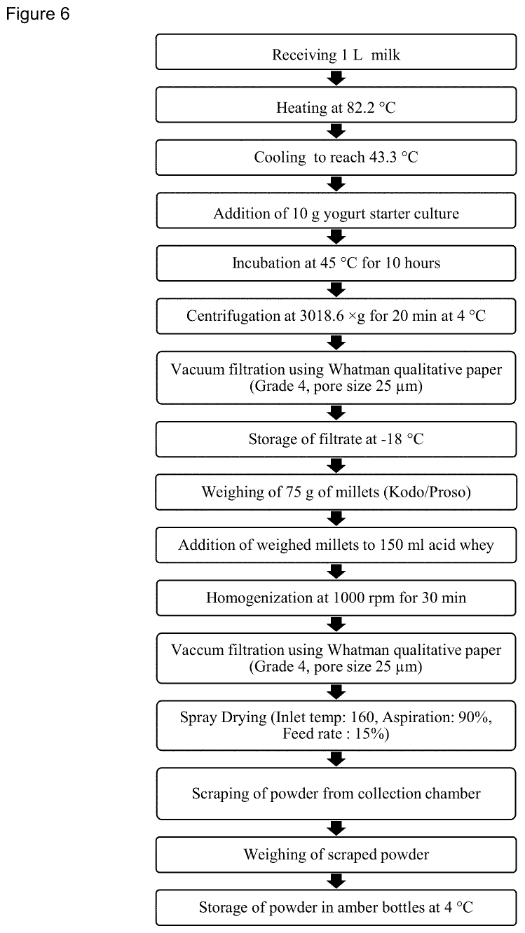

FIG. 7 is a process flow diagram for spray drying an acid whey-millet-folic acid matrix.

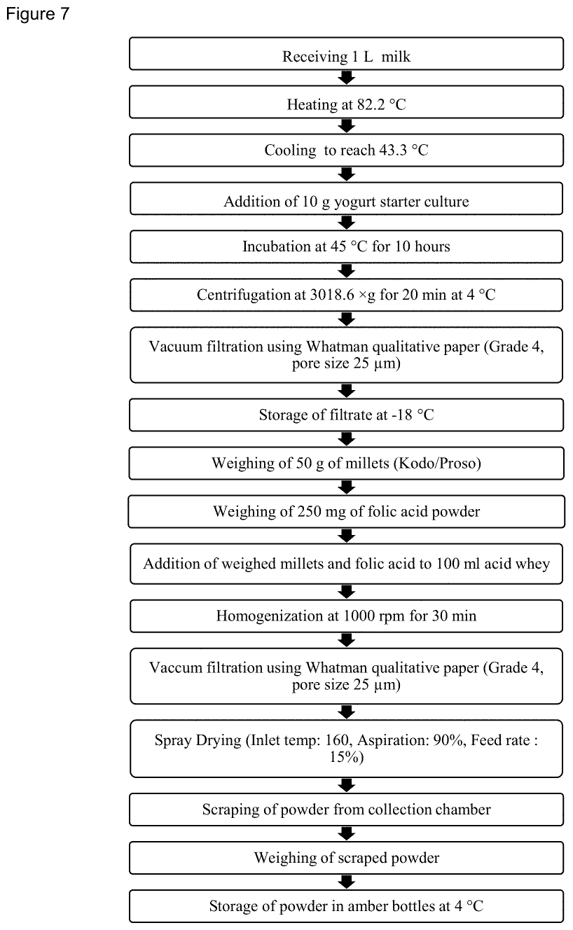

FIG. 8 is a graph showing bulk density (A) and tap density (B) values for spray-dried samples (KAW (12.5), KAW (25), KAW (50), PAW (12.5), PAW (25), PAW (50), and control samples (KO, PO and CBF). Different letters on the bar graph indicate significant difference among the samples.

FIG. 9 is a graph showing water solubility % (C) and dispersibility (D) values for spray-dried samples (KAW (12.5), KAW (25), KAW (50), PAW (12.5), PAW (25), PAW (50), and control samples (KO, PO and CBF). Different letters on the bar graph indicate significant difference among the samples.

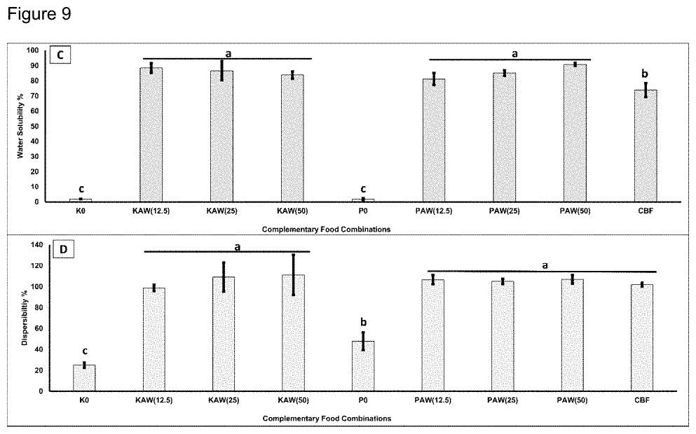

FIG. 10 contains images of scanning electron microscopy of pure kodo powder (a), spray dried kodo sample KAW (50) (b), pure proso powder (c) and spray dried proso sample PAW (50) as viewed at magnification 5000×.

FIG. 11 A is a graph showing the pH of acid whey-millet matrixes of different composition percentages for kodo millet. FIG. 11 B is a graph showing the pH of acid whey-millet matrixes of different composition percentages for proso millet.

FIG. 12 is a graph of the total polyphenol content observed for matrixes containing kodo or proso millet and acid whey, at different acid whey and millet compositions of 0%, 25%, 50%, 75% and 100% w/v.

FIG. 13 is a graph of tannin amount observed as catechin equivalent observed for matrixes containing kodo or proso millet and acid way, at different acid whey and millet compositions of 0%, 25%, 50%, 75% and 100% w/v.

FIG. 14 is a graph of phytate amount observed for matrixes containing kodo or proso millet and acid way, at different acid whey and millet compositions of 0%, 25%, 50%, 75%, and 100% w/v.

FIG. 15 A is a graph of amino acid content KAW (50) and PAW (50) distributed according essential amino acids. FIG. 15 B is a graph of amino acid content KAW (50) and PAW (50) distributed according to non-essential amino acids.

FIG. 16 is a graph of particle size distribution, by intensity, of spray dried particles formed from different acid whey-millet (AWM) matrix formulations.

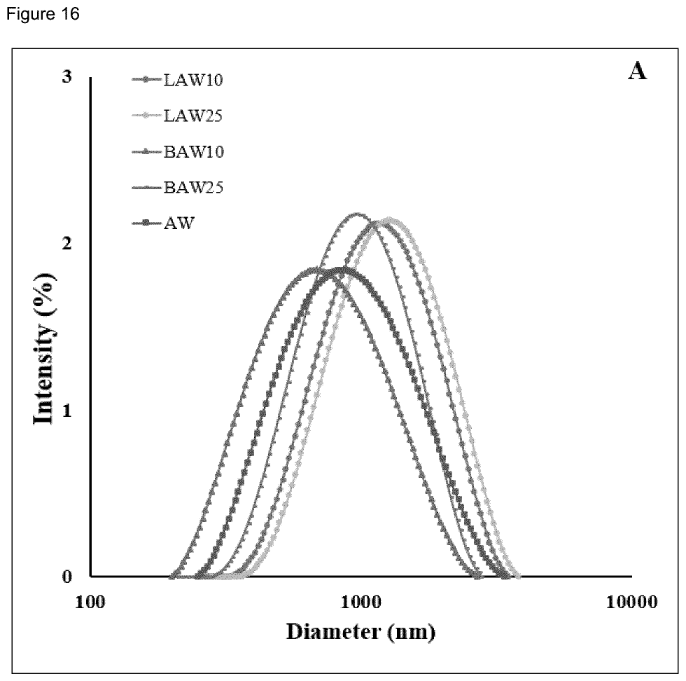

### DETAILED DESCRIPTION OF INVENTION

Acid whey generated from Greek yogurt manufacturing can be upcycled to develop value-added products by incorporating grains, including millets.

Advantageously, it is found that this process allows for a decrease in antinutritional factors, phytic acid, tannins and increase in total polyphenolic compounds were observed with millets+acid whey matrix. This indicates that the product provides the bioavailability of the nutrients present in the grain.

Millets are used as baby foods in rural communities of Asia and Africa. Millets are climate resilient ancient grains that are predominantly alkaline in nature. For example, the average pH of reconstituted finger and pearl millet flour are 8.50 and 8.30, respectively. They are nutritionally rich grains with proteins, fiber and mineral content much higher when compared to other cereal grains. Millets also contain phytochemicals, such as ferulic acid, lignans, carotenoids and flavonoids that have antioxidant properties. Millets are also considered prebiotics that can increase the viability of probiotics. There are various varieties of millets, including pearl, finger, proso, foxtail, barnyard, little, kodo, etc. Proso millet (Panicum miliaceum L.) originated in eastern Asia and later spread to different parts of the world including United States. It is a heat and drought tolerant crop that is primarily grown for animal and bird feed. It contains 13.6% protein with leucine, isoleucine and methionine as major amino acid, 70% carbohydrates, 3.8% fats, 3.3% minerals and dietary fiber content of 19.4%. The carbohydrate composition includes free sugars, starch, cellulose, pentosans, xylose, fructose, glucose, sucrose, maltose, raffinose etc. Similarly, kodo (Paspalum scrobiculatum) is also a nutritious grain and an excellent source of fiber that is grown majorly in India, Pakistan, Indonesia, Thailand, Vietnam and West Africa. When analyzed for various genotypes it has been found that it contains approximately an average of 8% protein with tryptophan, 66.6% carbohydrates, 1.4% fat, 2.6% of mineral content with iron and zinc amount being 32 ppm and 23 ppm respectively. It has also been reported that it contains 0.15 mg/100 g thiamine, 0.09 mg/100 g niacin and 2 mg/100 g riboflavin. Both proso and kodo are underutilized crops and have potential to be used in a more profitable manner.

One embodiment of the present invention is directed to forming a complementary food matrix can be made using acid whey and millets as main ingredients because of their nutritive and synbiotic properties with the help of spray drying operation. Both protein and carbohydrates present in the millets can act as encapsulants or wall material wherein the carbohydrates act as filling agents and amino acids act as copolymers. The wall material can protect the bioactive components present in the combined matrix of acid whey and millets such as carotenoids, flavonoids, polyphenols, vitamins, and minerals. Spray drying is an encapsulation method of producing dry powder from a liquid feed with the help of hot drying medium. The 3 stages of spray drying operation consists of atomization of liquid feed, drying of sprayed liquid with the help of drying medium and ultimately separation of dried product. In food processing industry, spray drying helps in food preservation, taste masking, encapsulation of flavors, bioactive components, etc.

Spray drying can also help in valorization of food waste products by using them as an encapsulating agent or as source of bioactive compounds that can be encapsulated.

The fundamental difficulty with spray-drying of acid whey is its high amount of lactic acid content which affects the crystal structure of the powder and decreases the yield. Lactic acid has also been found to limit the crystallization of lactose which ultimately causes lumping of the powder while in storage. However, millets are termed as potentially alkaline food that are consumed to maintain pH of the body. Hence, addition of millets to acid whey can potentially aid in neutralization of acid whey and producing a powder with nutritional benefits of both the components. This could be an alternative eco-friendly solution to replace current neutralization methods (using chemicals such as ammonium hydroxide, sodium hydroxide and sodium bicarbonate) widely used for processing of acid whey. It was observed that the pH of acid whey was 4.6 and addition of millets to acid whey, led to an increase in pH as shown in Table 8. Consequently, the percentage yield of spray-drying was found to be in the range of 83-94% with no significant differences in the composition and between different millet types.

### Method of Forming an Acid Whey-Based Food Product

One embodiment of the present invention is directed a method for forming an acid whey-based food product, the method comprising:
(a) preparing a matrix suitable for spray drying, wherein the matrix is a homogenous mixture comprising acid whey and flour; and
(b) spray drying the matrix to form a powder of dried matrix;
   thereby forming the acid whey-based food product.

Flour

The flour may be selected from the group consisting of amaranth, wheat, rice, sorghum, buckwheat, millets, teff, fonio, and combinations thereof and combinations thereof. In one embodiment, the flour is one or more millets selected from the group finger millet, little millet, barnyard millet, kodo millet, proso millet, pearl millet, foxtail millet, and combinations thereof.

Nutrient compositions for millets and sorghum are similar to other cereals (mainly carbohydrates, proteins, fat, crude fiber, minerals, vitamins) and are a rich source of energy (Table 1 and 2).

TABLE 1
Average nutritional composition of selected
millets and sorghum grains (g/100 g)

| | | | | | | Energy |
|---|---|---|---|---|---|---|
| Grain | Protein | Fat | Ash | Carbohydrate | Crude Fiber | (kcal) |
| Barnyard | 11.0 | 3.9 | 4.5 | 55.0 | 13.6 | 300 |
| Finger | 7.7 | 1.5 | 2.6 | 72.6 | 3.6 | 336 |
| Little | 9.7 | 5.2 | 5.4 | 60.9 | 7.6 | 329 |
| Maize | 12.1 | 4.6 | 1.8 | 66.2 | 2.3 | 358 |
| Rice | 7.5 | 2.4 | 4.7 | 78.2 | 10.2 | 362 |
| Sorghum | 10.4 | 3.1 | 1.6 | 70.7 | 2.0 | 329 |
| Wheat | 14.4 | 2.3 | 1.8 | 71.2 | 2.9 | 348 |

TABLE 2
Mineral and vitamins composition of millets and sorghum (mg/100 g)

| | Barnyard | Finger | Little | Sorghum | Maize | Rice | Wheat |
|---|---|---|---|---|---|---|---|
| Minerals | | | | | | | |
| Ca | 22 | 344 | 17 | 13 | 10 | 10 | 41 |
| P | 280 | 283 | 220 | 289 | 89 | 160 | 306 |
| K | — | 408 | 126 | 363 | 270 | 130 | 363 |
| Na | — | 11 | 7.9 | 2 | 37 | 6 | 3 |
| Mg | 82 | 137 | 61 | 165 | 0.163 | 32 | 120 |
| Fe | 18.6 | 3.9 | 9.3 | 3.4 | 2.3 | 0.5 | 3.9 |
| Cu | 0.60 | 0.47 | 0.05 | 1.7 | 0.22 | 0.25 | 0.9 |
| Mn | 0.96 | 5.49 | 0.68 | 1.6 | 0.163 | 1.1 | 13.3 |
| Zn | 3 | 2.3 | 3.7 | 1.7 | 0.46 | 1.2 | 1 |
| Vitamins | | | | | | | |
| Thiamin (Vitamin B1) | 0.33 | 0.42 | 0.30 | 0.33 | 0.155 | 0.41 | 0.41 |
| Riboflavin (Vitamin B2) | 0.10 | 0.19 | 0.09 | 0.1 | 0.055 | 0.0149 | 5.46 |
| Niacin (Vitamin B3) | 4.2 | 1.1 | 3.2 | 3.7 | 1.77 | 1.62 | 5.5 |

Both millets and sorghum have very low lipids content. The protein content in millets is usually variable and depends on the variety, cultivars, growing conditions. Millets and sorghum are rich in essential vitamins and minerals like potassium, calcium, magnesium, iron, and zinc. Especially finger millet, which has three times more calcium than milk. Millets and sorghum are both gluten-free, making them suitable for people with celiac disease. Millets are a rich source of phytochemicals and micronutrients. The ten phenolic compounds identified for finger millets and darker-colored finger millet varieties have higher phenolic contents and antioxidants. These nutritional factors make millets a suitable functional food that can potentially prevent or delay the occurrence of cardiovascular diseases. Sorghum contains higher polyphenols, flavonoids, and extractable phenolic acids than other major cereals. Phenolics in sorghum have been reported to have unique functional and bioactive properties in foods.

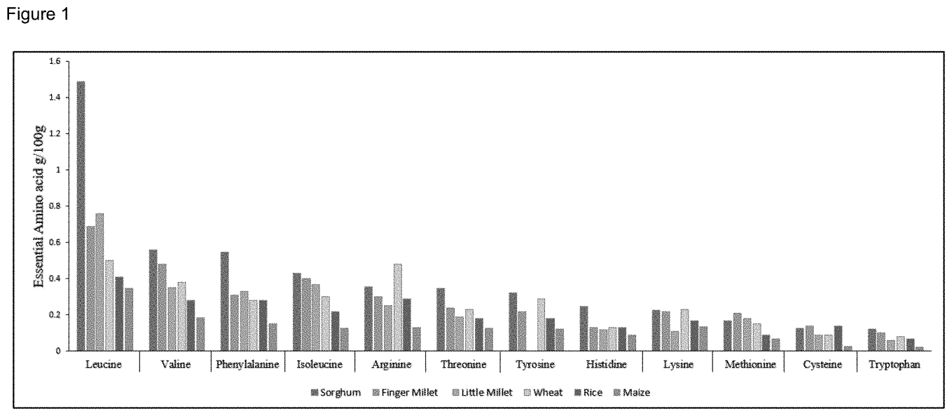

The amino acid composition of millets and sorghum is an important nutritional trait to consider when assessing protein quality. Amino acids play a major role in the synthesis of proteins and as intermediates in metabolism. Humans can synthesize all amino acids necessary except for the nine essential amino acids: histidine, isoleucine, leucine, lysine, methionine, phenylalanine, threonine, tryptophan, valine. Essential amino acids must be taken through the diet. A comparative amino acid profile for selected millets and sorghum is presented in FIG. 1. In general, millets and sorghum have higher levels of leucine, isoleucine, arginine, phenylalanine than other essential amino acids. Lysine is an important building block for synthesizing proteins in humans, and as with most grains, millets and sorghum are deficient in lysine.

The physical and functional characteristics of grains and flour describe their processing and storage properties. The grains' size, density, and porosity are essential parameters to know during equipment design and agricultural processes like sorting, mixing, storing, and transporting grains. Color is one of the most relevant characteristics related to grain quality as it affects the color of the resulting food and has implications on consumer preference. Functional properties of the flour, like solubility, water holding capacity, and dispersibility, reflect the interaction between the flour's composition and molecular structure. The moisture content and water activity of flour indicate product quality and shelf stability. 2,2-Diphenyl-1-picrylhydrazyl (DPPH) radical scavenging assay, thiobarbituric acid reactive substances (TBARS), and total phenolic content are among the most frequently used method for determining the antioxidant properties of plant extracts. One should carefully consider the effects of unit operations such as milling, kneading, and baking stages on the final quality of the products made using these underutilized grains. Therefore, understanding the physical and functional attributes of the grains is useful to selecting the best grain for transformation into value-added products.

Relative Amounts of Acid Whey and Flour in the Matrix

In one embodiment the matrix has a concentration in a range of about 10% (m/v) to about 100% (m/v) based on the mass of the flour in grams per volume of acid whey in milliliters. In another embodiment the matrix has a concentration in a range of about 50% (m/v) to about 100% (m/v) based on the mass of the flour in grams per volume of acid whey in milliliters.

Fermentation of the Matrix

In one embodiment, the matrix is fermented to provide the benefit(s) described herein. Typically, the duration of the fermentation is in a range from greater than 0 hours to about 48 hours before the spray drying. Interestingly, the fermentation process may, but is not required to, be carried out with the microorganism(s) present in the acid whey and flour.

Optional Constituents

In one embodiment, the matrix may further comprises an animal milk. The animal milk may be selected from the group consisting of cow milk, sheep milk, goat milk, donkey milk, camel milk, and combinations thereof. The animal milk may be included at a concentration of about 10% (m/v) to about 90% (m/v) of the matrix.

In one embodiment, the matrix may further comprise a plant-based milk/beverage. The plant-based milk/beverage may be selected from the group consisting of soy milk, almond milk, oat milk, millet milk, and combinations thereof. The plant-based milk/beverage is at a concentration of about 10% (m/v) to about 90% (m/v) of the matrix.

In one embodiment, the matrix may further comprise a combination of animal milk and a plant-based milk/beverage. The relative amounts of each may be varied between greater than 0% to less than 100% of one and the difference of the other. This combination may be at a concentration of about 10% (m/v) to about 90% (m/v) of the matrix.

Acid Whey-Based Food Product

The above-described process yields an acid whey-based food product that is a powder comprising particles, wherein each particle comprises homogeneous mixture of dried acid whey and flour.

Free Flowing Powder

In one embodiment the acid whey-based food product is free flowing. The free flowing nature may be quantified in terms of the Carr Index and the Hausner ratio (both of which are described in more detail in the Examples). In one such embodiment, the acid whey-based food product has a Carr Index in a range of about 2 to about 20. In another such embodiment, the acid whey-based food product has a Hausner ratio in a range of about 1 to about 1.5. In yet another such embodiment, the acid whey-based food product has a Carr Index in a range of about 2 to about 20 and a Hausner ratio in a range of about 1 to about 1.5.

Dispersibility and Solubility of the Acid Whey-Based Food Product in Water

Dispersibility describes the ability of particles to break down when they are mixed in water after passing through a sieve of 150 μm. Various studies have confirmed that dispersibility depends on the size and shape of particles along with salt, lactose and protein composition. The quantification of dispersibility of the food product is described in more detail in Example 2. In one embodiment, the acid whey-based food product has dispersibility percentage in a range of about 80% to about 90%. Advantageously, the dispersibility percentage of spray dried powders and commercial baby food was found to have no significant difference (p>0.05) indicating that the spray dried powder was able to distribute as uniformly as the commercial baby food in water.

Water solubility is an important property as it measures the amount of the powder that can dissolve in water when determined at a specified temperature. The water solubility of spray-dried powders was found to be significantly higher, as compared to flour (raw powder). In one embodiment, the acid whey-based food product of claim having a water solubility index (WSI) in a range of about 70% to about 90%.

The water absorption index (WAI) measures the volume occupied by the acid whey-based food product after swelling in excess water. In one embodiment, the acid whey-based food product has a water absorption index (WAI) in a range of about 10 to about 25.

Color of the Acid Whey-Based Food Product

The color of the acid whey-based food product may be relevant in terms of acceptable appearance to consumers as a food and/or as a whitening agent.

The color may be quantified according to the Commission Internationale d′Eclairage (CIE) L*a*b system (described in more detail in the Examples). In one embodiment, the acid whey-based food product has a color quantified to the Commission Internationale d′Eclairage (CIE) L*a*b system, of L in a range of about 70 to about 98, *a in a range of about −1 to about 1.5, and *b in a range of about 0.9 to about 20.

The color may also be quantified in terms of Chroma (described in more detail in the Examples). In one embodiment, the acid whey-based food product has a Chroma in a range of about 1 to about 10.

The color may also be quantified in terms of Hue (described in more detail in the Examples). In one embodiment, the acid whey-based food product has a Hue in a range of about 0.9 to about 97.

In one embodiment, the acid whey-based food product has the foregoing CIE L*a*b color, Chroma, and Hue.

Moisture Content and Water Activity of the Acid Whey-Based Food Product

The flow properties of the acid whey-based food product also affected by its moisture content. In particular, moisture content influences the flow properties of the powder and affects the stickiness, caking and clumping tendency of the powder. In one embodiment, the acid whey-based food product has a moisture content in range of about 3% to about 10% (w/w). In another embodiment, the moisture content is in a range about 4% to about 6% (w/w). Advantageously, the moisture content of commercial food powders usually falls in the range of 1-5%.

Water activity is a critical measure of growth of microorganisms wherein a high water activity indicates greater availability of water and easier growth of microorganisms and a water activity of 0.97 is ideal for the growth of Clostridium botulinum, Escherichia coli, Bacillus subtilis and Listeria monocytogenes. There is no microbial proliferation when the water activity is 0.6 and the water activity of commercial powder is usually around 0.2. In one embodiment, the acid whey-based food product has a water activity (Aw) in a range of about 0.2 to about 0.9. In another embodiment, the acid whey-based food product has a water activity (Aw) in a range of about 0.2 to about 0.4.

Refractive Index

In one embodiment, the acid whey-based food product, upon being reconstituted at 1 gram of powder to 10 mL of deionized water, has a refractive index in a range of about 1 to about 2.

Particle Size and Zeta Potential

In one embodiment, the acid whey-based food product has a particle size in terms of cumulant diameter that is in a range of about 1 μm to about 20 μm.

In one embodiment, the acid whey-based food product has a zeta potential in a range of about ±10 mV to about ±30 mV.

Antinutritional Factors

In one embodiment, the acid whey-based food product has a total phenol content (TPC) of about 3 mg GAE/g dry extract to about 6 mg GAE/g dry extract.

In one embodiment, the acid whey-based food product has a tannin amount quantified as catechin equivalent (CE) in a range of about 250 ppm to about 18,000 ppm.

In one embodiment, the acid whey-based food product has a phytic acid amount quantified as a maximum phytate amount in a range of about 1,000 mg/100 g sample to about 2,000 mg/100 g sample.

In other embodiments, the acid whey-based food product has all the possible combinations of the foregoing total phenol content, tannin amount, phytic acid amount.

### EXAMPLES

### Example 1: Physical and Functional Properties of Ancient Grains and Flours

This study is to assess differences in physical, functional, and antioxidant properties between barnyard millet (Echinochloa utilis), finger millet (Eleusine coracana), little millet (Panicum sumatrense), and white sorghum (Sorghum bicolor), in order to develop food products with improved nutritional value.

### Materials

White sorghum and finger millet were obtained from Babco Foods International LLC (New Jersey, USA). Barnyard and little millets were obtained from Manna foods (Chennai, India). Millet and sorghum grains were milled using a Butterfly Matchless 750-watt mixer grinder to get flour.

Acetic acid, gallic acid, and 2,2-diphenyl-1-picrylhydrazyl (DPPH) were obtained from Acros Organics (Morris Plains, N.J.). Folin-Ciocalteu, Thiobarbituric acid (TBA), Malondialdehyde tetrabutylammonium salt (MDA) were obtained from Sigma (St. Louis, Mo.). Ethanol was purchased from Thermo Fisher Scientific (Hampton, N.H.). Sodium bicarbonate was purchased from Duda Energy LLC (Decatur, Ala.).

### Statistical Analysis

The generated data were subjected to one way-analysis of variance (ANOVA) and the Tukey HSD (honest significance difference) test was used to compare means. Data was analyzed using JMP 14.0 software (SAS Institute Inc, Cary, N.C.). Significance was accepted at 95% confidence interval (p<0.05). Results were expressed as mean±standard deviation.

### Physical Properties

Grain Size Analysis

Grain size analysis was estimated using the National Institutes of Health (NIH) inspired open-source image analysis software ImageJ. ImageJ is an open-source program for image processing and analysis. Schneider, C. A., Rasband, W. S., Eliceiri, K. W., 2012, NIH Image to ImageJ: 25 years of image analysis, Nat. Methods. It can be used to calculate the area, pixel values, distance, and angle of user-defined selections. ImageJ supports standard image processing functions such as contrasting, smoothing, sharpening, and filtering. More details on ImageJ can be found in the ImageJ user guide. Ferreira, T., & Rasb, W., (2012), ImageJ user guide: IJ 1.46 r. The area of the major and minor axis were measured, and the diameter of the grains was calculated using Eq (1).

$$Diameter D = 2 \sqrt{\frac{A}{π}} \qquad Eq ( 1 )$$

A is the area of the grain.

Grains were spread out on a plain sheet of white paper with a 1 cm scale placed at the bottom. The scale was used to obtain dimensions in mm since images give dimensions in pixels. Grains were arranged without touching or overlapping each other to simplify the image processing process. Images were captured with a Samsung Galaxy S8 camera with resolutions at about 1440×2960 pixels. The images were then converted to 8-bit binary images. The calibration of the scale was done with the known scale that was placed in the image. Then a part of the image was selected for analysis.

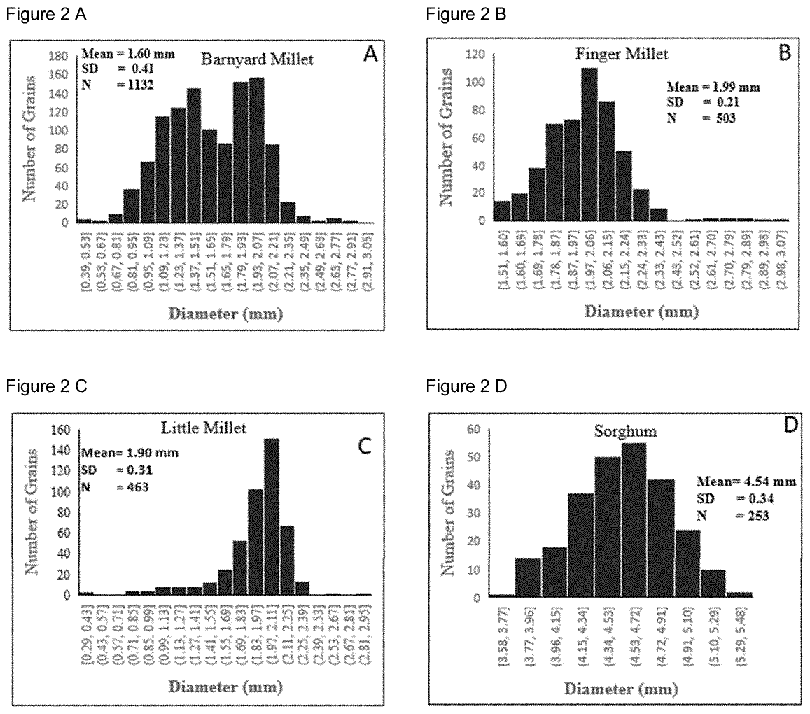

The diameter of the grains is given in FIG. 2. The diameter ranged between 0.39 to 3.05 mm±0.41 for barnyard millets, 1.51 to 3.07 mm±0.21 for finger millet, 0.29 to 2.95 mm±0.31 for little millet and 3.58 to 5.48 mm±0.34 for sorghum. Variability among different cultivars, varieties of millets, and sorghum grown at other geographical and climatic conditions should be considered.

### Density Measurements

Bulk density (ρb) was determined according to the method described by Zungur Bastioğlu et al. Zungur Bastioğlu, A., Tomruk, D., Koç, M., Ertekin, F. K., 2016, Spray dried melon seed milk powder: physical, rheological and sensory properties, J. Food Sci. Technol. 53, 2396-2404. Approximately 4 g of grains was measured into a 10 mL graduated cylinder. The bulk density was calculated by dividing the sample weight by the sample volume. For the tapped density (ρt), the cylinder was mechanically tapped using a shaker at 1000 rpm for 20 minutes. Jinapong, N., Suphantharika, M., Jamnong, P., 2008, Production of instant soymilk powders by ultrafiltration, spray drying and fluidized bed agglomeration, J. Food Eng. 84, 194-205. The bulk density of flour was measured using 2 g of flour and followed the same procedure used to measure grains. The experiment was replicated six times, and the average value was recorded.

$$Bulk density ( kg / {m}^{3} ) = \frac{Weight of grains ( kg )}{Volume of grains ( {m}^{3} )} \qquad Eq ( 2 )$$

The true density of the grains was determined using a gas pycnometer (Quantachrome Ultrapycnometer 1000 Anton Paar, Graz, Austria). Four grams of grains were placed in the sample cell. A known quantity of helium under pressure was allowed to flow into the sample cell containing the material. True grain density was expressed as the ratio of the weight of grains in the sample cell to the volume measured by the pycnometer. The equipment was set to multi-run three times, and the average value was displayed. This process was repeated six times with a different grain sample. Before use, the pycnometer was calibrated according to the manufacturer's recommendation. The results are shown in Table 5 below.

The analysis showed that bulk density values ranged from 784.3 to 800 kg/m³ for barnyard millet, 784.3 to 800 kg/m³ for little millet, 769.2 to 800 kg/m³ for finger millet, and 689.7 to 769.2 kg/m³ for Sorghum. The low bulk density value of finger millets could imply that of all the grains finger millet would occupy the least space during storage.

The result shows that the bulk density of the flours was highest with finger millets (696.74±29.72 kg/m³) and lowest on little millets flour (553.59±31.44 kg/m³). Flours with higher bulk densities indicate their suitability for use in food preparations, while lower bulk density flours are more suitable for weaning food formulation preparation. Since little millets had the least bulk density, it could be beneficial in formulating complementary foods.

Bulk density is an essential parameter in determining the separation, cleaning, sorting, packaging, and transportation requirement of particulate or powdery foods. Tapped density is the bulk density obtained after mechanically tapping a container and was used to calculate porosity. To obtain consistently reproducible results, a mechanical shaker at a fixed rate and time was used to determine tapped density in this study. True density was determined using the gas pycnometer instead of the water displacement method due to the small size of the grains that could cause some of the grains to float in water.

Porosity

Porosity is defined as the ratio of void spaces inside the grain to the apparent volume of the grains. The porosity of grains was calculated from the bulk density and true density values using the Equation described by Jain & Bal. Jain, R. K., Bal, S., 1997, Properties of pearl millet, J. Agric. Eng. Res. 66, 85-91.

$$Porosity ε ( \% ) = \frac{( ρ t - ρ b )}{ρ t} \times 1 \; 00 ρ b = bulk density and ρ t = true density \qquad Eq ( 3 )$$

Porosity values was calculated based on the relationship between bulk and true densities. The mean porosity results varied from 45.49±0.29% for barnyard millet, 44.92±0.71% for finger millet, 45.24±0.89% for little millet and 20.02±1.07% for sorghum.

Flow Characteristics

The flow characteristics of the grain and flour samples were measured by calculating the Carr Index and Hausner ratio from the bulk density (ρb) and tapped density (ρt) values. Carr, R. L., (1965), Evaluating flow properties of solids, Chem. Eng., 18, 163-168; Hausner, H. H., (1967), Friction conditions in a mass of metal powder, Polytechnic Inst. of Brooklyn, Univ. of California, Los Angeles. Carr compressibility index (CI) and Hausner ratio (HR) were calculated using equations (4) and (5), respectively.

$$Carr Index CI = \frac{ρ t - ρ b}{ρ t} \times 100 \qquad Eq ( 4 )$$

$$Hausner Ratio ( HR ) = \frac{ρ t}{ρ b} \qquad Eq ( 5 )$$

The Carr's compressibility index (CI) and the Hausner ratio (HR) of the grains were used to determine the flow properties of the grains and flours. CI and HR results presented in Table 5 were interpreted as shown in Table 3.

TABLE 3
Classification of flowability of powder

| Flow Character | Hausner Ratio | CI % |
|---|---|---|
| Excellent/very free flow | 1-1.1 | ≤10 |
| Good/free flow | 1.12-1.18 | 11-15 |
| Fair | 1.19-1.25 | 16-20 |
| Passable | 1.26-1.34 | 21-25 |
| Poor/cohesive | 1.35-1.45 | 26-31 |
| Very poor/very cohesive | 1.46-1.59 | 32-37 |
| Very, very poor/approx. non-flow | >1.60 | >38 |

TABLE 4
Classification of flowability of powder based on repose angle

| Description | Repose Angle |
|---|---|
| Very free flowing | <30° |
| Free flowing | 30-38° |
| Fair to passable flow | 38-45° |
| Cohesive | 45-55° |
| Very cohesive (non-flowing) | >55° |

The CI and HR values for all the grains and flour indicated excellent flowability with no significant difference between the grains.

Angle of Repose

Angle of repose is the angle formed between the slope of the pile and a horizontal plane when the pile is stationary. The angle of repose of the grains was determined using the vertical cylinder method described by Akaaimo & Raji. Akaaimo, D. I., Raji, A. O., 2006, Some Physical and Engineering Properties of Prosopis africana seed, Biosyst. Eng. 95, 197-205. A cylinder open at both ends was placed on a horizontal surface and filled with grains, then the cylinder was carefully lifted to create a heap. The base and diameter of the heap were measured, and the angle of repose was calculated using Equation (6). The angle of repose of flour was determined using a modified version of the fixed funnel method described by Beakawi Al-Hashemi & Baghabra Al-Amoudi. Beakawi Al-Hashemi, H. M., Baghabra Al-Amoudi, O. S., 2018, A review on the angle of repose of granular materials, Powder Technol. A funnel with a wide opening was attached to a stand at a distance 10 cm above a horizontal table surface. Two grams of grains was poured through the funnel to create a heap, and the height and diameter were measured using Equation (6).

$$Angle of repose ( ° ) = {tan}^{- 1} ( \frac{2 H}{D} ) where H = height of the heap , \\ D = Diameter of the heap \qquad Eq ( 6 )$$

The angle of repose values for millet and sorghum grains and flour are shown in Table 5 and was interpreted according to the classifications shown in Table 4. There was a significant difference (p>0.05) between the angle of repose of the grains with values ranging from 14.5° for finger millet and 21.2° for little millet. The low angle of repose values could be due to the fact that raw grains are round and easily slide on each other, resulting in a lower angle of repose. Materials with a low angle of repose flow easily and can be transported using very little energy. There was no significant difference in the angle of repose for the flours. The vertical cylinder and funnel methods were employed to measure the angle of repose of grains and flour due to the limited quantity of samples available.

TABLE 5
Some physical properties of millets and sorghum

| | Barnyard millet | Finger millet | Little millet | Sorghum |
|---|---|---|---|---|
| Grain properties | | | | |
| Bulk Density Kg/m³ | 797.4 ^{a} ± 5.9 | 787.0 ^{a} ± 10.6 | 794.8 ^{a} ± 7.4 | 728.2 ^{b} ± 25.4 |
| True Density Kg/m³ | 1462.9 ^{a} ± 3.7 | 1428.8 ^{b} ± 3.5 | 1451.6 ^{ab} ± 10.5 | 1403.3 ^{c} ± 25.3 |
| CI % | 3.7 ^{a} ± 2.4 | 3.2 ^{a} ± 2.9 | 5.0 ^{a} ± 1.50 | 5.7 ^{a} ± 3.0 |
| Hausner | 1.0 ^{a} ± 0.0 | 1.0 ^{a} ± 0.0 | 1.1 ^{a} ± 0.0 | 1.1 ^{a} ± 0.0 |
| Porosity % | 45.5 ^{a} ± 0.3 | 44.9 ^{a} ± 0.7 | 45.2 ^{a} ± 0.9 | 48.1 ^{b} ± 2.7 |
| Angle of Repose (°) | 21.2 ^{a} ± 1.0 | 14.5 ^{b} ± 3.9 | 21.2 ^{a} ± 1.2 | 20.0 ^{a} ± 1.1 |
| Water Activity | 0.4 ^{a} ± 0.0 | 0.4 ^{b} ± 0.0 | 0.4 ^{c} ± 0.0 | 0.4 ^{d} ± 0.01 |
| Flour properties | | | | |
| Bulk Density kg/m³ | 570.6 ^{b} ± 40.7 | 696.7 ^{a} ± 29.7 | 553.6 ^{b} ± 31.4 | 580.4 ^{b} ± 30.8 |
| CI % | 11.1 ^{a} ± 1.7 | 9.7 ^{a} ± 4.7 | 7.9 ^{a} ± 2.5 | 11.8 ^{a} ± 2.4 |
| Hausner | 1.1 ^{a} ± 0.0 | 1.1 ^{a} ± 0.1 | 1.1 ^{a} ± 0.0 | 1.1 ^{a} ± 0.0 |
| Angle of Repose (°) | 30.8 ^{a} ± 2.8 | 31.1 ^{a} ± 3.5 | 30.8 ^{a} ± 2.7 | 29.5 ^{a} ± 4.4 |
| Water solubility % | 1.4 ^{a} ± 0.2 | 2.6 ^{a} ± 0.7 | 5.0 ^{b} ± 2.2 | 2.8 ^{a} ± 0.5 |
| Water holding capacity (g/g) | 1.1 ^{b} ± 0.1 | 1.4 ^{a} ± 0.1 | 1.1 ^{b} ± 0.1 | 1.4 ^{a} ± 0.1 |
| Moisture Content (%) * | 7.7 ^{a} ± 0.1 | 8.3 ^{b} ± 0.2 | 8.5 ^{b} ± 0.2 | 7.8 ^{a} ± 0.1 |
| Water Activity | 0.4 ^{a} ± 0.0 | 0.4 ^{a} ± 0.0 | 0.4 ^{a} ± 0.0 | 0.4 ^{a} ± 0.0 |
| Dispersibility % | 33.8 ^{ab} ± 6.5 | 28.8 ^{ac} ± 5.0 | 45.5 ^{d} ± 5.8 | 30.3 ^{bc} ± 5.0 |

The mean ± standard deviation, n = 6. Values followed by the same letters in the same row indicate no significant difference by the Tukey HSD test at 5% level of significance (p < 0.05).
* n = 4

Color

Color measurements of grains and flour was done using a Chroma Meter (Konica Minolta CR-410, Chiyoda, Tokyo, Japan) to get the L*, a*, and b* color parameters. The L*, a* and b* values stand for lightness, greenness/redness, and blueness/yellowness, respectively. The chromameter was calibrated against the values on a white sample provided by the manufacturer. Six measurements were taken for each of the grain and flour samples, and the average value was reported. Color difference (ΔE), chroma, and hue angle (θ°) were calculated using Equation (7), (8), and (9).

$$Δ E = \sqrt{( {L}_{1}^{*} - {L}^{*} ) + ( {a}_{1}^{*} - {a}^{*} ) + ( {b}_{1}^{*} - {b}^{*} )} \qquad Eq ( 7 )$$

$$Chroma ( C * ) = \sqrt{( {a}^{* 2} ) + ( {b}^{* 2} )} \qquad Eq ( 8 )$$

$$Hue angle ( h * ) = {tan}^{- 1} ( \frac{b *}{a *} ) \qquad Eq ( 9 )$$

Table 6 shows the results of the color measurements of grain and flour samples as recorded in terms of the L* (Lightness), a* (redness/greenness), b* (yellowness/blueness), C* (chroma), and H° (Hue angle) values. Color values varied significantly (p<0.05) among the grains.

TABLE 6
Color characteristics of Sorghum and Little, Barnyard and Finger millets

| | L | a* | b* | C | h* | Δ e |
|---|---|---|---|---|---|---|
| Grain Color | | | | | | |
| Barnyard | 65.6^{a} ± 0.4 | 3.9^{c} ± 0.0 | 21.1^{a} ± 0.1 | 21.5^{a} ± 0.1 | 79.7^{a} ± 0.0 | — |
| Finger | 24.1^{b} ± 0.2 | 8.8^{a} ± 0.1 | 3.2^{b} ± 0.1 | 9.4^{b} ± 0.2 | 20.1^{b} ± 0.3 | — |
| Little | 57.7^{c} ± 0.6 | 3.9^{c} ± 0.1 | 20.0^{c} ± 0.2 | 20.3^{c} ± 0.2 | 79.1^{c} ± 0.0 | — |
| Sorghum | 54.38^{d} ± 0.54 | 5.18^{b} ± 0.1 | 22.9^{d} ± 0.3 | 23.5^{d} ± 0.3 | 77.3^{d} ± 0.2 | — |
| Flour Color | | | | | | |
| Barnyard | 78.3^{b} ± 0.8 | 1.7^{a} ± 0.0 | 17.3^{a} ± 0.2 | 17.3^{a} ± 0.2 | 84.5^{a} ± 0.0 | 23.5^{c} ± 0.6 |
| Finger | 55.1^{d} ± 0.9 | 4.6^{b} ± 0.1 | 8.2^{b} ± 0.2 | 9.4^{b} ± 0.2 | 61.0^{b} ± 0.1 | 53.9^{a} ± 4.8 |
| Little | 78.0^{b} ± 0.5 | 1.8^{c} ± 0.0 | 16.3^{c} ± 0.1 | 16.4^{c} ± 0.2 | 83.7^{c} ± 0.8 | 23.1^{c} ± 0.3 |
| Sorghum | 74.0^{c} ± 0.6 | 2.2^{d} ± 0.0 | 18.4^{d} ± 0.2 | 18.6^{d} ± 0.2 | 83.3^{d} ± 0.0 | 27.6^{b} ± 0.4 |

Mean ± standard deviation, n = 6. Values followed by the same letters in the same column indicate no significant difference by the Tukey HSD test at 5% level of significance (p < 0.05).

Barnyard millet grains had the highest L* value of 65.79 to 65.55±0.35, and finger millet grains had the least at 23.94 to 24.24±0.16. A similar L* value trend was noted for the flour samples. After milling, the lightness (L*) values for all the flours increased. Color is an important grain quality parameter that affects the resulting product and could influence consumer acceptance.

Water Solubility

The flour's solubility was determined by the method described by Singh and Singh. Singh, J., Singh, N., Sharma, T. R., Saxena, S. K., 2003, Physicochemical, rheological and cookie making properties of corn and potato flours, Food Chem. 83, 387-393. Two grams of flour sample was placed in a 50 mL centrifuge tube. Distilled water (30 mL) was added, and the mixture was placed in a shaking water bath for 30 minutes at 37° C. The mixture was centrifuged at 5000 rpm for 5 minutes and the supernatant was decanted and dried in a 225° C. oven for two hours. Solubility was calculated using Equation (10).

$$Water solubility ( \% ) = \frac{weight of dried supernatant}{weight of dried sample} \times 100 \qquad Eq ( 10 )$$

Water solubility is a critical quality parameter that affects the acceptance of a product by consumers. The solubility index of flour is its ability to dissolve in water. There was a significant difference (p<0.05) between the solubility values of the flours. Solubility index values ranged from 4.99±2.18% for little millet to 1.42±0.15% for barnyard millet (Table 5). According to these results, all the samples can be considered as non-soluble. The difference in water solubility could be because of the high starch content and low protein content and fat in finger millet.

Water Holding Capacity

Water holding capacity was determined using the method of Dayakar Rao et al. with slight modifications. Dayakar Rao, B., Anis, M., Kalpana, K., Sunooj, K. V., Patil, J. V., Ganesh, T., 2016, Influence of milling methods and particle size on hydration properties of sorghum flour and quality of sorghum biscuits, LWT—Food Sci. Technol. 67, 8-13. The flour sample (1.5 g) was placed in a pre-weighed centrifuge tube to which 5 mL of distilled water were added. The mixture was vigorously vortexed for 15 seconds and centrifuged at 5000 rpm for 10 minutes. The supernatant was poured into aluminum dishes and dried for 2 hours at 130° C. Water holding capacity (WHC) according to the weight of samples was calculated by using Equation (11).

$$Water holding capacity ( g / g ) = \frac{\begin{matrix}weight of wet sample - \\ weight of dried precipitate\end{matrix}}{weight of dry sample} \qquad Eq ( 11 )$$

Water holding capacity measures the amount of water absorbed by starch and is used as an index of gelatinization. The flours' water holding capacity ranged from 1.08±0.06 to 1.43±0.09 g/g, with sorghum flour having the highest value and barnyard flour with the lowest value. The high-water absorption observed in sorghum and finger millet could be due to their high starch content since starch and proteins contain hydrophilic parts that enhance water uptake.

Water Activity

The water activity (Aw) was measured with a water activity meter (Cx-2, Decagon Devices, Inc., Pullman, Wash., 99163) with a 0.001 sensitivity at room temperature.

The grains' water activity varied significantly, with sorghum having the highest mean value and finger millet with the lowest mean value. There was no significant difference in the water activity of the flour samples. The water activity of sorghum and millet flours ranged between was 0.37±0.00 to 0.41±0.01, indicating high microbial stability.

Moisture Content

The moisture content of the flour was measured with a halogen moisture analyzer (HE53, Mettler Toledo, Columbus, Ohio 43240). The procedure was repeated four times for all flour samples.

The moisture content of barnyard flour varied significantly at 7.7±0.07% to 8.5±0.19% for little millet. Moisture content and water activity of flour are important physical properties of grains and flour and good indicators of storage stability.

Dispersibility

Dispersibility was measured using the method described by Jinapong et al. Jinapong, N., Suphantharika, M., Jamnong, P., 2008, Production of instant soymilk powders by ultrafiltration, spray drying and fluidized bed agglomeration, J. Food Eng. 84, 194-205. One gram of grain flour was added to 10 mL distilled water and poured into a 50 ml beaker. The sample was stirred vigorously with a spatula for 15 seconds. The wet mixture was poured through a sieve (212 μm). The sieved sample was transferred onto a pre-weighed aluminum pan and dried in an oven at 105° C. until it is completely dry. The dispersibility was calculated according to Equation (12).

$$\% Dispersibility = \frac{( 10 + W ) \times \% TS}{W \times ( \frac{100 - M C}{100} )} \\ MC = moisture content of the flour , \\ \% TS = percentage of dry matter \\ in the wet flour mixture after sieving , and \\ W = weight ( g ) of the flour sample . \qquad Eq ( 12 )$$

Dispersibility is a measure of the rehydration ability of flour or starch. The higher the dispersibility, the better the sample reconstitutes in water. Finger millet had the least mean dispersibility value of 28.78±4.97%, while little millet had the highest mean value of 5.53±5.84%. Lower dispersibility values observed for the flours imply that the flour samples may clump during rehydration.

### Antioxidant Properties

Preparation of Extracts for the Determination of Total Phenolic Content

The extracts were prepared according to the method described by Maliak & Singh. Maliak, C. P., & Singh, M. B., (1980), Estimation of total phenols in plant enzymology and histoenzymology, Plant enzymology and histoenzymology: A text manual, Kalyani Publishers, New Delhi. Flour samples (0.5 gram) was weighed into a 15 mL centrifuge tube and 5 mL 80% ethanol was added to it as a solvent. The mixture was centrifuged at 5000 rpm for 20 minutes and the supernatant saved. To the sediment, 2.5 mL of 80% ethanol was added, and the mixture was centrifuged for 20 minutes at 5000 rpm. The supernatant was recovered and added to the supernatant from the previous step. The supernatant was covered with aluminum foil and allowed to stand for 24 hours. After 24 hours, 5 mL of distilled water was added to the residue to obtain sample extract.

Preparation of Extract for DPPH and TBARS

The extracts were prepared according to the method described by Maliak & Singh. One-half (0.5) gram of flour was weighed into a 15 mL centrifuge tube, and 5 mL of ethanol was added to it as a solvent. The sample was mixed and left to stand for 24 hours. After 24 hours the mixture was centrifuged at 5000 rpm for 20 minutes. The supernatant was recovered and used for analyses.

Total Phenolic Content

The evaluation of total phenol content of the flour samples was done using a modified version of the Folin-Ciocalteu method described by Maliak & Singh. Sample extract (2 mL) was added to scintillation vials and made up to 3 mL with distilled water. One-half of a milliliter (0.5 mL) of Folin-Cioclateu reagent was added to each vial. After 3 minutes, 20% sodium bicarbonate was added to each vial. The mixture was placed in boiling water for one minute then allowed to cool to room temperature. The absorbance of the mixture was then read at 650 nm using distilled water as blank. Gallic acid was used as a reference, and the results were expressed in milligrams of gallic acid (GAE) per gram of the sample extract.

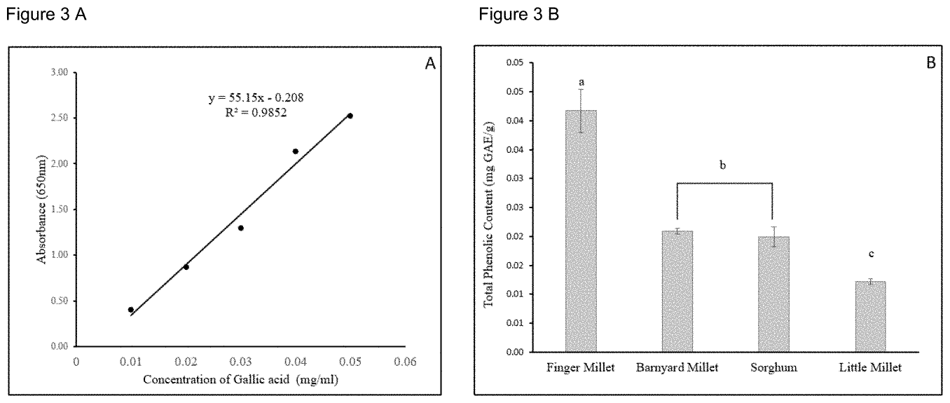

Phenolic compounds are the major contributors to the antioxidant activity of cereals. The total phenolic contents were determined using the Folin Ciocalteu (FC) method, and results (FIG. 3) are expressed in terms of the gallic acid equivalent (GAE) in mg/g of the extract. The FC method has been validated as the standard method for determining total polyphenols in plant extracts. Kupina, S., Fields, C., Roman, M. C., & Brunelle, S. L., (2018), Determination of total phenolic content using the Folin-C assay: Single-laboratory validation, Journal of AOAC International, 101(5), 1466-. The TPC of the four grains are shown in FIG. 3B. The highest TPC was found among the grains in finger millet (0.042 mg GAE/g) and the lowest in little millet (0.012 mg GAE/g). The phenolic compounds content in millet and sorghum grains would vary depending on the morphological fraction, variety, climate, and cultivation methods used.

DPPH Radical Scavenging Activity

Antioxidant activity was determined using the method described by Horvat et al. Horvat, D., Sĭmić, G., Drezner, G., Lalić, A., Ledenc̆an, T., Tucak, M., Plavs̆ić, H., Andrić, L., Zdunić, Z., 2020, Phenolic Acid Profiles and Antioxidant Activity of Major Cereal Crops, Antioxidants 9, 527. To each flour sample, 0.2 mL was taken and added to a mixture of 1 mL 0.5 mMol/L 2,2-diphenyl-1-picrylhydrazyl (DPPH) ethanol solution and 2 mL ethanol. The mixture was incubated in a dark place for 30 minutes. Absorbance was measured at 517 nm. All experiments were repeated four times (n=4). The percentage of inhibition of free radical DPPH was calculated against blank using Eq (13). For the blank, the sample was replaced with ethanol in the mixture. The DPPH scavenging activity was measured using Eq (13).

$$DPPH \% scavenging activity ( \% Inhibition ) = \\ 1 - ( \frac{A s a m p l e}{A b l a n k} ) \times 100 {A}_{sample} = Absorbance of the samples at time = 30 minutes \\ and {A}_{b l a n k} = Absorbance of the blank at time = 0. \qquad Eq ( 13 )$$

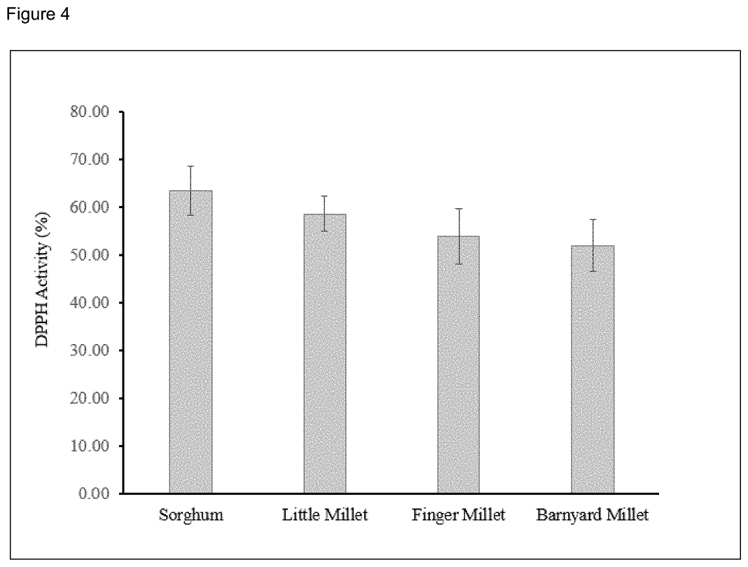

The DPPH assay method is based on the reduction of DPPH, a stable free radical with purple color absorbed at 517 nm. Antioxidants neutralizes DPPH free radicals resulting in a discoloration that indicates the antioxidant efficacy. As seen in FIG. 4, the DPPH radical scavenging activity ranged from 51.97% for little millet to 63.99% for finger millet. However, there was no significant difference in the DPPH activities of the grains.

Thiobarbituric Acid Reactive Substances (TBARS) Test

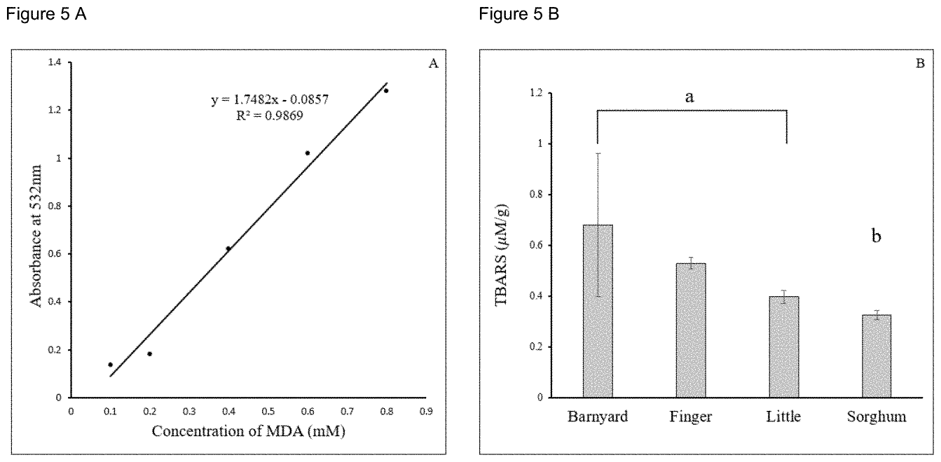

Lipid oxidation using TBARS method was measured as described by Zed & Ullah. Zeb, A., Ullah, F., A Simple Spectrophotometric Method for the Determination of Thiobarbituric Acid Reactive Substances in Fried Fast Foods, J. Anal. Methods Chem. 2016. A 4.0 mM standard solution of thiobarbituric acid (TBA) was prepared in acetic acid. The sample extract (1 mL) was mixed with 1 mL TBA reagent. The mixture was heated in a boiling water bath at 95° C. for 1 hour. The mixture was cooled to room temperature, and the absorbance was measured using UV-visible spectrophotometer at 532 nm. Malondialdehyde tetrabutylammonium (MDA) salt was used as a reference and different concentrations of 0.1, 0.2, 0.4, 0.6, and 0.8 mM MDA were prepared (FIG. 5A). The TBARS was calculated using Eq (14).

TBARS(μM/g)=(Ac×V)/W Eq (14)
where Ac is the concentration determined from the calibration curve, and W is the weight of the sample taken, and V is volume in mL of the total extract prepared.

Thiobarbituric acid reactive substance (TBARS) is a widely known method for detecting lipid oxidation. Shahidi, F., Zhong, Y., 2015. Measurement of antioxidant activity. J. Funct. Foods. The TBARS assay measures the pink pigment formed through the reaction of thiobarbituric acid (TBA) and malondialdehyde (MDA) in the presence of heat. The spectrophotometric method for TBA analysis was used in this study because it is a simpler and cost-effective alternative to HPLC procedures. Absorbance was measured at 532 nm. The TBARS concentration was highest in barnyard millet at 0.6803 μM/g and lowest in sorghum at 0.3257 μM/g (FIG. 5B). Similar result were reported for wheat flour.

### Conclusions

This study showed significant variations in the physical properties of the grains. Barnyard and little millet grains were found to have comparable properties, while finger millet and sorghum grains differed significantly from the rest of the grains. The mean values obtained for the diameter of barnyard millet, finger millet, little millet, and sorghum were 1.60, 1.99, 1.90, and 4.54 mm, respectively. There was no significant difference in the flow properties of the grains and flour. Bulk density, true density, porosity, color attributes, solubility, water holding capacity, and dispersibility varied significantly between the flours. Little millet had the highest solubility of the raw grains at 4.99%. Results indicated the presence of antioxidant activity in all the grains. The highest DPPH antioxidant activity was found in sorghum and little millet. Total phenolic content and TBARS were highest in barnyard millet and finger millet.

### Example 2: Physical Properties of Spray Dried Acid Whey-Millet Powder

### Material and Methods

Acid Whey Preparation

Greek yogurt was prepared by inoculation of 10 g of yogurt starter culture containing Lactobacillus delbrueckii subsp. bulgaricus, Streptococcus salivarius subsp. thermophilus, and supplemental probiotic cultures, Lactobacillus bifidus, Lactobacillus acidophilus and Lactobacillus casei in 1 L of pasteurized milk (Grade A, Vitamin D fortified whole milk, Central Dairy, Columbia, Mo., USA). The milk was first heated to 82° C. (180° F.) and cooled to 43.3° C. (110° F.) before the addition of the culture. After addition of the culture, the product was kept in an incubator at 45° C. for 8 hours. The separation process was carried out using a centrifuge (Beckman Coulter™ Model J6-MI, Indianapolis, USA) at 3908×g for 20 min at 4° C. After centrifugation, the obtained acid whey was vacuum filtered using Whatman qualitative paper (Grade 4, pore size 25 μm).

Millet Processing

Kodo and proso millet powders were prepared by grinding 500 g of grains for 5 minutes in a mixer grinder (Butterfly Rapid Mixer Grinder™, Butterfly Gandhimati Appliances®, Chennai, India). The powder was then sieved using a 212 μm sieve using a sieve shaker and stored at 4° C.

Matrix Preparation

The sample matrix was prepared by mixing millet powder in the acid whey at percentage composition of 12.5, 25 and 50 (w/v %) for both kodo and proso millet, as shown in Table 7. The mixing was done in a 400 mL glass beaker using a metal spatula. The mixture was then passed through a vacuum filter using Whatman qualitative paper (Grade 4, pore size 25 μm) and the pH of the permeate was obtained using a pH meter (Mettler Toledo, Columbus, Ohio, USA). The experimental samples included pure proso powder, pure kodo powder and a commercially manufactured and available baby food powder as control samples.

TABLE 7

| | | Weight of | Volume of | |
|---|---|---|---|---|
| | | millet | acid whey | Concentration |
| Sample ID | Sample | (g) | (mL) | (%) |
| K0 | Kodo | — | — | Pure Kodo Powder |
| KAW (12.5) | Kodo | 18.75 | 150 | 12.5 |
| KAW (25) | Kodo | 37.5 | 150 | 25 |
| KAW (50) | Kodo | 75 | 150 | 50 |
| P0 | Proso | — | — | Pure Proso Powder |
| PAW (12.5) | Proso | 18.75 | 150 | 12.5 |
| PAW (25) | Proso | 37.5 | 150 | 25 |
| PAW (50) | Proso | 75 | 150 | 50 |
| CBF | Commercial | — | — | — |
| | Baby Food | | | |

Spray Drying

The spray drying of the obtained permeate was performed using a spray dryer (Mini Spray Dryer B-290, New Castle, Del., USA). The operation was carried out at between 120-160° C., the flowmeter for spraying air, feed flow rate, aspirator was adjusted for maximum yield. The outlet temperature and time of operation were noted for each run. The run was conducted in triplicates. The powder obtained from the system was collected in clean scintillation vials.

The spray dried powders and control samples were analyzed based on their physical properties. The powder was characterized on the basis of its color, moisture content, water activity, density, flow character, and reconstitution properties.

The spray drying was conducted based on a full factorial study design with factors fixed at composition percentage and millet type (kodo and proso). The analysis was conducted using JMP software (Cary, N.C., USA). For the post-hoc test, Tukey's honest significant difference (HSD) test was used. Tukey's honest significant test helps to describe the pairwise difference among the samples present, it also controls the probability of type 1 error to occur. Significance of the results were considered at alpha value of 0.05.

Yield Percentage and Moisture Content

After the spray drying operation, the powder was collected from both the collection chamber and cyclone separator. The collected powder was then weighed to calculate the recovery and respective yield percentage (Table 8). The yield of the obtained powder was calculated based on the formula given in equation 15.

$$Yield \% = \frac{Solid content in spray dried powder ( g )}{\begin{matrix}Solid content in the feed \\ to be spray dried ( g )\end{matrix}} \times 100 \qquad Eq ( 15 )$$

A high yield of powder was obtained, as mentioned in Table 8, and no difference was obtained in the yield of kodo and proso millet (p>0.05).

The moisture content was analyzed using a moisture analyzer (Model number HE53, Mettler Toledo, Columbus, Ohio, US) and water activity was obtained using a water activity meter (Aqua lab model CX-2, Pullman, Wash.). Moisture content influences the flow properties of the powder and affects the stickiness, caking and clumping tendency of the powder. The moisture content of the powders (shown in Table 8) was in the range of 4.17-5.38% (w/w). The moisture content of commercial food powders usually falls in the range of 1-5%.

The water activity of the powders was in the range of 0.24 to 0.28 (Table 8). Water activity is a critical measure of growth of microorganisms wherein a high water activity indicates greater availability of water and easier growth of microorganisms and a water activity of 0.97 is ideal for the growth of Clostridium botulinum, Escherichia coli, Bacillus subtilis and Listeria monocytogenes. There is no microbial proliferation when the water activity is 0.6 and the water activity of commercial powder is usually around 0.2. Hence, it can be concluded that both moisture content and water activity values were approximately near the range of commercial standards for food powders.

TABLE 8
Summary of spray-drying parameters with yield %, moisture content and
water activity values of the obtained spray dried powder samples.

| | Inlet Temp. | Outlet Temp. | pH of the | Yield | Moisture Content | Water Activity |
|---|---|---|---|---|---|---|
| Sample ID | (° C) | (° C) | inlet feed | (%) | (%) | (Aw) |
| KAW (12.5) | 140 | 69 | 5.09 ± 1.27 ^{a} | 94.06 ± 1.16 ^{a} | 4.78 ± 0.11 ^{a} | 0.26 ± 0.01 ^{a} |
| KAW (25) | 140 | 69 | 5.12 ± 0.08 ^{a} | 93.00 ± 2.31 ^{a} | 4.69 ± 0.02 ^{a} | 0.26 ± 0.08 ^{a} |
| KAW (50) | 140 | 69 | 5.4 ± 0.04 ^{a} | 93.22 ± 1.39 ^{a} | 5.38 ± 0.42 ^{a} | 0.28 ± 0.03 ^{a} |
| PAW (12.5) | 140 | 59 | 4.89 ± 2.34 ^{a} | 93.24 ± 2.58 ^{a} | 4.17 ± 0.31 ^{a} | 0.24 ± 0.02 ^{a} |
| PAW (25) | 140 | 59 | 5.01 ± 1.76 ^{a} | 89.11 ± 2.51 ^{a} | 4.37 ± 0.15 ^{a} | 0.26 ± 0.12 ^{a} |
| PAW (50) | 140 | 59 | 5.26 ± 2.98 ^{a} | 83.41 ± 3.82 ^{a} | 4.60 ± 0.32 ^{a} | 0.25 ± 0.05 ^{a} |

Each measured value is the mean of observations taken 3 times ± standard deviation.
Different superscripts indicate significantly different values of mean (p < 0.05) in the same column.

Color Analysis

The color measurement was done using a Colorimeter (Konika Minolta® CR-410, Ramsey, N.J., USA) according to Commission Internationale d′Eclairage (CIE) LAB system as mentioned above. According to the CIE, color values were obtained for each of the powder samples (Table 9), wherein L is an indicator of lightness value representing how white the sample is, +a corresponds to red color, −a corresponds to green color, −b indicates blue color, and +b represents yellow color. The delta E value was calculated to compare the color of obtained powder with commercial baby food available in the market, wherein the “1” identifies the sample to which the comparison is being made (e.g., the commercial baby food).

TABLE 9
Summary of color values (L, a, b, delta E, hue and chroma)
of spray dried powder samples and control samples.

| Samples | L value* | a value* | b value* | Delta E* | Hue* | Chroma* |
|---|---|---|---|---|---|---|
| K0\hat{ } | 74.72 ± 0.26^{c} | 1.36 ± 0.01^{a} | 8.78 ± 0.14^{c} | 14.04 ± 0.29^{a} | 80.82 ± 0.00^{a} | 8.88 ± 0.15^{b} |
| KAW (12.5) | 97.79 ± 0.39^{a} | 0.33 ± 0.01^{b} | 3.07 ± 0.01 ^{e} | 17.97 ± 0.16^{a} | 96.17 ± 0.00^{a} | 1.58 ± 2.63^{d} |
| KAW (25) | 91.22 ± 0.07^{a} | −0.28 ± 0.03^{b} | 3.56 ± 0.00 ^{e} | 14.10 ± 0.09^{a} | 94.64 ± 0.00^{a} | 1.88 ± 2.92^{d} |
| KAW (50) | 88.98 ± 0.07^{a} | −0.34 ± 0.01^{b} | 3.61 ± 0.00 ^{e} | 13.47 ± 0.03^{a} | 95.41 ± 0.04^{a} | 1.93 ± 2.95^{d} |
| P0\hat{ } | 79.52 ± 0.73^{c} | −0.11 ± 0.01^{b} | 13.21 ± 0.52^{b} | 8.31 ± 0.54^{b} | 91.14 ± 0.00^{a} | 13.60 ± 0.18^{a} |
| PAW (12.5) | 93.59 ± 0.04^{a} | −0.16 ± 0.02^{b} | 4.21 ± 0.00^{d} | 14.53 ± 0.03^{a} | 92.24 ± 0.00^{a} | 4.21 ± 0.00^{c} |
| PAW (25) | 92.84 ± 0.07^{a} | −0.48 ± 0.06^{b} | 4.51 ± 0.01^{d} | 13.89 ± 0.09^{a} | 94.01 ± 0.08^{a} | 4.56 ± 0.09^{c} |
| PAW (50) | 90.91 ± 0.05^{a} | −0.04 ± 0.03^{b} | 4.85 ± 0.00^{d} | 12.82 ± 0.03^{a} | 90.58 ± 0.00^{a} | 4.85 ± 0.00^{c} |
| CBF\hat{ } | 86.65 ± 0.48^{b} | −0.78 ± 0.02^{c} | 17.29 ± 1.24^{a} | — | 92.56 ± 0.01^{a} | 17.31 ± 1.24^{a} |
| Titanium | 97.84 ± 0.41^{a} | 0.14 ± 0.16^{b} | 0.94 ± 0.03^{a} | 19.62 ± 0.26 | 0.95 ± 0.06^{a} | 1.42 ± 0.15^{a} |
| dioxide\hat{ } | | | | | | |

Each value is the mean of measurements taken 6 times ± standard deviation.
\hat{ }Control samples.
Different superscripts indicate significantly different values of mean (p < 0.05) in the same column.

According to the sample color values, as shown in the Table 9, high L values were obtained of the spray-dried powders with 12.5% kodo in acid whey sample having the highest L value (97.79), highest a value was observed for pure kodo sample (1.36) and highest b value (17.29) was observed for commercial baby food sample. The highest L value (97.79) is similar to that of the titanium dioxide. On the basis of these obtained values, hue angle was calculated. Hue describes perception of color in its purest form described by the most dominant wavelength. It is also defined as the degree of redness and yellowness wherein 0 or 360 stands for red, 90 for yellow, 180 for green and 270 for blue. The hue angle value ranged from 80.82-96.17 indicating the yellowness in the samples with no significant difference amongst the pure millet powder and spray dried powder. Chroma values were also calculated describing the strength of the hue value and level of saturation and low chroma values were observed. High chroma value defines a pure color without presence of gray or white color stipulating highly reflective materials at value 20 or fluorescent surfaces at 30. In conclusion, the color of the spray-dried powder was found to be significantly different from the commercial baby food powder with a higher lightness value indicating a whiter color.

Bulk & Tap Densities

For bulk density measurements, about 2 g of the powder sample were gently poured into a 25 mL glass graduated cylinder and the corresponding volume was noted as viewed in the cylinder. The calculations were done using equation 16.

$$Bulk Density ( g / mL ) = \frac{Mass of the powdered sample ( g )}{\begin{matrix}Volume of powdered sample \\ in the graduated cylinder ( ml )\end{matrix}} \qquad Eq ( 16 )$$

Tap density was calculated by mechanically tapping the 25 mL graduated cylinder containing 2 g of sample, 1250 times using an electronic shaker. On the basis of the obtained density values, Hausner ratio and Carr index value were calculated for finding the flowability character as described above.

Density of the particles help in determining the ease of transportation and handling of the powder. Bulk density is defined as mass of sample bulk that is contained in a unit volume including interparticle voids as well. It also describes the spatial arrangement. There are three categories of density, viz., aerated, poured and tap. Aerated bulk density involves aeration of the sample for maximum volume, poured bulk density involves pouring of the sample in a graduated cylinder and tapped bulk density involves tapping of the sample. The functional properties of these powders depend on different intrinsic and extrinsic factors. The intrinsic properties affecting the powder functional properties include composition, structure, charge and hydrophobicity. The extrinsic parameters include temperature, salt concentration and effect of processing.

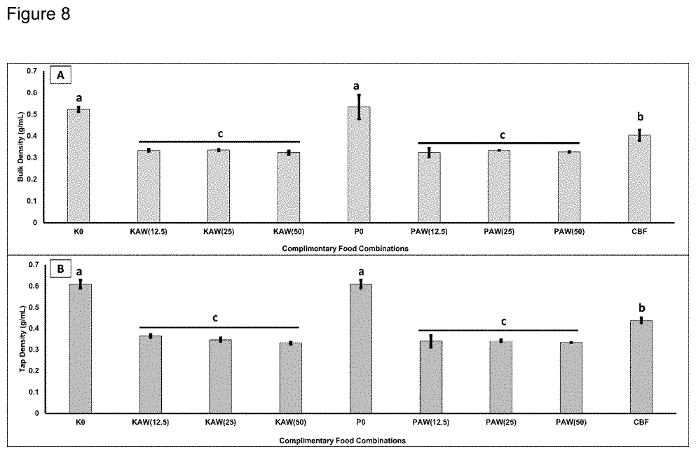

The bulk density of raw millet powder and commercial baby food was found to be significantly different (<0.05), as compared to the spray-dried powders (FIG. 8). The bulk density of spray-dried powders was found to be lower, irrespective of composition percentage and millet type. Bulk density varies with factors like particle size, distribution, friction and cohesive forces between the particles. These factors decide the extent to which the particles will collapse and fill in the interspatial voids. For example, it was found that spray-dried powder of whey protein isolate tend to have large vacuoles, which give it a hollow particle characteristic that leads to a lower bulk density value. The bulk density of commercial infant formulas were found to be between 413 to 516 kg/m³. Spray-dried sweetened yogurt powder was found to have a bulk density that is between 344 to 475 kg/m³. The bulk density is affected by the inlet air temperature and pressure in the atomizer wherein a decrease in the bulk density was observed with an increase in the inlet temperature.

Consequently, the difference between the bulk and tapped density explains how much the powder sample is compressible. The results obtained for tapped density also had similar results wherein the spray-dried samples were found to be significantly different (p<0.05) from the pure millet samples and commercial baby food. Tapped density has been found to be higher for particles that have a regular shape. In the experiment, the tapped density was found to be in a range of 333 to 440 kg/m³.

Hausner Ratio and Carr Index are parameters that help in determining the compressibility and flow properties of a powder. Hausner ratio is the ratio of tapped and bulk density. If the interparticle interactions or friction of the powder are not significant, then the value for both the densities are almost similar and hence, the powder is characterized as free flowing with a ratio value in range of 1-1.1. Similarly, Carr Index (CI) measures the stability of the powder. If the CI % is less than 10%, then the powder is considered to have excellent flowability. As shown in Table 10, the Hausner ratio and Carr Index of the spray dried powder particles show they are similar to the commercial baby food powder with a very free flowing consistency.

Conventionally, a higher inlet temperature can affect the nutritional composition and consequently functional properties of the ingredients used in the formulation. Hence, based on pre-experiments a lower temperature of 140° C. was considered as the inlet temperature for the spray drying operation to obtain a free-flowing powder.

Another physical property determined by the powder particles is the angle of repose. It describes the ease of storage and processing of the powder sample. In the food industry, a lower angle of repose is desired. The angle of repose also explains the flowability character of the sample wherein a sticky powder particle would have a high angle of repose, less flowability and vice versa. In the experiment, the range of angle of repose of all the samples was found to be 24.71 to 33.31° and no significant differences were found amongst the different samples (p>0.05).

Angle of Repose

For calculation of the angle of repose, 5 g of powdered sample were weighed and transferred gently through a plastic funnel of an outlet diameter of 1 cm. The height and base diameters of the obtained heap were noted to calculate tan θ value. Fitzpatrick, J., (2013), Powder properties in food production systems, Handbook of Food Powders, pp. 285-308. The calculations were done using equation 17.

$$Tan θ = \frac{2 \times Height ( cm )}{Base Diameter ( cm )} \qquad Eq ( 17 )$$

TABLE 10
Summary of flow character of spray-dried and control sample
deduced using angle of repose, Hausner ratio and Carr Index.

| Sample ID | Angle of Repose | Hausner Ratio | Carr Index | Flow Character |
|---|---|---|---|---|
| K0^{\hat{ }} | 26.52 ± 0.97 ^{a} | 1.16 ± 0.03 ^{a} | 13.90 ± 2.92 ^{a} | Good/Free Flow |
| KAW (12.5) | 27.40 ± 0.43 ^{a} | 1.10 ± 0.02 ^{b} | 8.87 ± 2.42 ^{b} | Excellent/Very Free Flowing |
| KAW (25) | 29.11 ± 2.60 ^{a} | 1.04 ± 0.03 ^{b} | 3.34 ± 2.87 ^{b} | Excellent/Very Free Flowing |
| KAW (50) | 29.68 ± 0.72 ^{a} | 1.02 ± 0.00 ^{b} | 2.13 ± 0.85 ^{b} | Excellent/Very Free Flowing |
| P0\hat{ } | 32.90 ± 2.88 ^{a} | 1.15 ± 0.11 ^{a} | 13.90 ± 2.92 ^{b} | Good/Free Flow |
| PAW (12.5) | 24.72 ± 3.51 ^{a} | 1.05 ± 0.02 ^{b} | 4.38 ± 2.17 ^{b} | Excellent/Very Free Flowing |
| PAW (25) | 29.39 ± 2.58 ^{a} | 1.03 ± 0.00 ^{b} | 3.30 ± 0.06 ^{b} | Excellent/Very Free Flowing |
| PAW (50) | 33.31 ± 2.92 ^{a} | 1.02 ± 0.00 ^{b} | 2.17 ± 0.916 ^{b} | Excellent/Very Free Flowing |
| CBF\hat{ } | 27.13 ± 0.95 ^{a} | 1.09 ± 0.04 ^{ab} | 7.96 ± 3.59 ^{b} | Excellent/Very Free Flowing |

Each value is the mean of measurements taken 3 times ± standard deviation.
\hat{ }Control samples.
Different superscripts indicate significantly different values (p < 0.05) in the same column.

Particle Morphology

The morphology of powder particles comprising of their size and the shape significantly influences its flow behavior and reconstitution properties.

Scanning Electron Microscopy was done to compare the morphology of raw powder of millets and spray dried powder of millet and acid whey matrix. The analysis was conducted with the help of Electron Microscopy Core Facility, University of Missouri-Columbia. The samples were mounted using carbon adhesives and were sputtered with 25 nm Pt for the imaging. FEI Quanta 600F ESEM (Hillsboro, Oreg., United States) was used for the analysis. The images were taken under high vacuum condition with voltage of 5 kV, working distance adjusted to 8 mm, objective aperture 30 μm and 3.5 spot size. The particle size analysis was conducted using open-source image processing FIJI software.

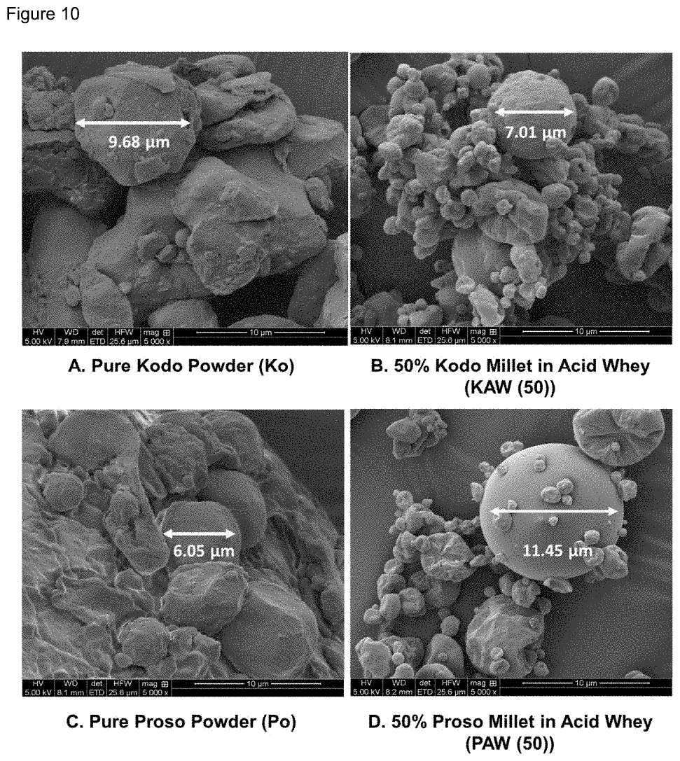

A significant change was observed between the morphology of raw kodo and proso millet powder as compared to the spray dried powders of the millet and acid whey matrix as shown in FIG. 10. For the pure powders, more agglomeration was observed indicating interaction between the protein and starch.

The pure powder particles had a rough surface appearance and spray dried powder had comparatively smoother surface and spherical shape. The sphericity of the particles increases the flowability and packing of the powder and hence, the free-flowing character of the powder can be justified. Some of the spray dried particles had dents on them with wrinkled surface. This appearance and variation in particle size can be attributed to the influence of atomization, drying rate and variation in drying time. For example, the difference in the appearance of smaller and larger particles is because of higher initial heat and mass transfer coefficient of smaller particles that leads to fast rate of evaporation.

According to FIG. 10, the average particle size diameter for kodo powder was observed 9.5 μm with the largest particle stretching to 19.7 μm. For the spray dried kodo powder, the diameter of the particles ranged from 2.5-7.16 μm. Similarly, for the proso powder the average length of the clustered particle diameter was 9.45 μm and the diameter of spray dried powder ranged from 3-11.45 μm.

Reconstitution Properties of Powder

The reconstitution or rehydration properties hold immense importance as they define the quality of the complementary food product. These properties are influenced by the composition of the food product and processing conditions. For each sample, there will be a different set of quality characteristics, because of the varied surface tension of components, such as protein, fats, carbohydrates, vitamin and minerals in the powder when it comes in contact with water. The composition of insoluble particles primarily consists of fats and proteins that form a network when mixed with water. In a processing condition, the most important parameter that determines the physicochemical properties of powder while spray drying is the inlet temperature which affects the moisture content and hygroscopicity of the powder.

The reconstitution properties are primarily described by wetting, dissolving and dispersing properties. These properties determine if the solid mass will rapidly agglomerate. Water solubility is an important property as it measures the amount of the powder that can dissolve in water when determined at a specified temperature. The water solubility of spray-dried powders was found to be significantly higher, as compared to raw powders. The range of solubility % of the spray-dried samples was found to be 81 to 90%. No difference was found in the kodo and proso spray-dried samples.

Similarly, dispersibility describes the ability of particles to break down when they are mixed in water after passing through a sieve of 150 μm. Various studies have confirmed that dispersibility depends on the size and shape of particles along with salt, lactose and protein composition.

The dispersibility percentage of spray dried powders and commercial baby food was found to have no significant difference (p>0.05) indicating that the spray dried powder was able to distribute as uniformly as the commercial baby food in water. However, a significant difference was found when compared with powdered raw millets wherein the raw millet powders had lower dispersibility. A prior study in the art characterizing pearl millet flour after supplementation with soybean flour found dispersibility was affected with changes in pH, wherein dispersibility was found to improve with an increase in acidity. Likewise, in this study, the pH of the reconstituted spray dried powders ranged from 4.89 to 5.14 and corresponded to higher dispersibility, as compared to raw powder that had a reconstituted pH of 6.24 for kodo powder and 6.63 for proso powder. The pH also influences the growth of microorganisms wherein most bacteria grow at pH values of 6.5-7, however, the target pH of commercial baby food is around 7.

Water Solubility

For finding water solubility, 2 g of the powdered sample was weighed and mixed with 30 mL DI water. The solution was then stirred for a minute and poured into a 50 mL plastic centrifuge tube. The tube was shaken in a constant temperature shaking bath (Yamato™, Model number BT-25, Tokyo, Japan) for 30 minutes at 37° C. The conical tube was then centrifuged at 3018.6×g for 5 minutes at 25° C. and the supernatant was poured into an aluminum dish and weighed. The poured solution was then dried in oven (Hobart HEC20, Troy, Ohio, USA) at 105° C. and the dried powder was weighed after complete drying. The calculation was done on the basis of equation 10 (above).

Dispersibility

One gram (1 g) of powder was weighed and mixed with 10 mL of DI water in a 50 mL beaker and was mixed well using a spatula. The mixture was then passed through a sieve size 212 μm (Model #4041, Hogentogler & CO, MD, USA) and the permeate was collected and weighed in an aluminum dish. For the calculation as per equation 19, total solid content of permeate and moisture content of powder were obtained. For total solid content, the permeate was then dried in an oven (Hobart HEC20, Troy, Ohio, USA) at 105° C. for 30 min. After drying the weight of aluminum dish was taken to estimate the solid matter and calculations were done based on equation 18. The moisture content values were obtained using moisture analyzer (Model number HE53, Mettler Toledo, Columbus, Ohio, USA) and calculations were done.

$$Total Solid \% = \frac{\begin{matrix}Weight of dry matter \\ in filtered permeate ( g )\end{matrix}}{\begin{matrix}Weight of liquid \\ filtered permeate ( g )\end{matrix}} \times 100 \qquad Eq ( 18 )$$

$$Dispersibility \% = \frac{\begin{matrix}[ 10 + weight of powder ) \times \\ \% Total Solid in filtered permeate \end{matrix}}{\begin{matrix}weight of powder \\ [ \begin{matrix}100 - Moisture content \\ of powder \%\end{matrix} ] / 100\end{matrix}} \qquad Eq ( 19 )$$

### Conclusions

Addition of millets (kodo & proso) in acid whey eased the spray-drying operation with increases in pH and yielded (83-94%) a high amount of powder. The obtained powder had physicochemical properties similar to a commercial baby food powder in terms of moisture content and water activity. The L value for color measurements was observed to be higher for spray dried powder (L=88 to 97) as compared to the commercial baby food (L=86) indicating increase in whiteness value. The bulk and tap density of the spray-dried powders was found to be lower, however all the powders were observed to have a free-flowing property, as deduced by Carr Index and Hausner ratio. The reconstitution properties were found to be similar to the commercial baby food with a high water solubility percentage and a high dispersibility percentage. The reported study supports food processing techniques for upcycling of acid whey as an effective step to develop new value-added products. Future research direction includes assessment of the nutritional profile and probiotic properties of the raw matrix and spray-dried powders. The complementary food formed from the matrix of acid whey and millets has the potential to solve the undernutrition problem among children and, at the same time, provide an efficient system for upcycling acid whey.

### Example 3: Decrease in Antinutritional Factors, Increase in Polyphenolic Compounds, and Increased Bioavailability of Nutrients in an Acid Whey-Millet Matrix

### Materials and Method

Acid Whey Preparation

Acid whey was removed from the yogurt. The yogurt was prepared by inoculation of 10 g of yogurt starter culture into 1 L of pasteurized milk (Grade A, Vitamin D whole milk, Central Dairy, Columbia, Mo., USA) that was heated at 82.2° C. and cooled to 43.3° C. The starter culture was added after cooling step and consisted of Lactobacillus delbrueckii subsp. bulgaricus, Streptococcus salivarius subsp. thermophilus, and supplemental probiotic cultures, Lactobacillus bifidus, Lactobacillus acidophilus and Lactobacillus casei. The incubation was done at 45° C. for 8 hours. Centrifugation process (Beckman Coulter™ Model J6-MI, Brea, Calif., USA) was performed for separation at 3018.6×g×g for 20 min at 4° C. After centrifugation, the acid whey was vacuum filtered using Whatman qualitative paper (Grade 4, pore size 25 μm) and stored at −18° C. in a freezer for further use.

Millet Processing

Millet powders were used for the experiment. The powder was obtained by processing both Kodo and Proso grains in a mixer grinder (Butterfly Rapid Mixer Grinder™, Butterfly Gandhimati Appliances®, Chennai, India) respectively.

Millet Matrix Preparation

Millet matrix was prepared by mixing powdered kodo and proso millet (Manna Ethnic Millets®, Southern Health Foods Ltd™, Chennai, India) with acid whey, respectively, at concentration as shown in Table 11. Homogenized mixing was maintained by vortexing (Bench Mixer™) samples for 3 min each.

TABLE 11
Millet matrix preparation using kodo
and proso millet and acid whey.

| | | Weight of | Vol. of | |
|---|---|---|---|---|
| | | millet | acid whey | Concentration |
| Sample ID | Millet Type | (g) | (mL) | (%) |
| AW | — | — | 10 | 0 |
| KAW (25) | Kodo | 2.5 | 10 | 25 |
| KAW (50) | Kodo | 5 | 10 | 50 |
| KAW (75) | Kodo | 7.5 | 10 | 75 |
| KAW (100) | Kodo | 10 | 10 | 100 |
| PAW (25) | Proso | 2.5 | 10 | 25 |
| PAW (50) | Proso | 5 | 10 | 50 |
| PAW (75) | Proso | 7.5 | 10 | 75 |
| PAW (100) | Proso | 10 | 10 | 100 |

*The fermentation was performed for 24 h at room temperature 25° C.

Physicochemical Characteristics

The pH of the samples was measured using a digital pH meter (Mettler Toledo™ Columbus, Ohio, USA) with a pH electrode (In Lab® Expert Pro-ISM) for 0, 3, 6, 24 and 48 hr. Before taking the measurements, the pH meter was calibrated using a standardized buffer solution at pH 2.00, 4.00, 7.00 and 10.00.

Water Activity and Moisture Content

Water activity was obtained by using a water activity meter (Aqua Lab model CX-2, Pullman, Wash., USA). The samples were kept in the water activity cups and the value at equilibrium after drying in oven for 1 hr. Moisture content was calculated by following AOAC 1999 method. The method involved oven-drying (Hobart™ electric convection oven, Model #DN98, Troy, Ohio, USA) the samples at 105° C. for 3 hours and weighing them. The calculations were done based on equation 20.

$$Moisture content ( wet basis ) \% = \frac{\begin{matrix}Initial weight - \\ final weight ( g ) )\end{matrix}}{( Initial weight ( g )} \times 100 \qquad ( 20 )$$

### Antinutritional Factors

Total Phenol Content

For quantification of phenolic compounds, the Folin-Ciocalteu method was used (Singleton & Rossi, 1965). The method involves obtaining a blue-colored solution due to the presence of phosphomolybdic-phosphotungstic-phenol complex when the active extracts or fractions react with Folin-Ciocalteu reagent in an alkaline medium. After obtaining the absorbance values from the extracts, the phenolics contents were calculated from the regression equation of the calibration curve expressed in Gallic acid Equivalent (GAE) as milligrams per gram of the extract or fraction (mg GAE/g extract or fraction). First, 0.5 g of sample was weighed and combined with 5 mL of 80% ethanol in a mortar and pestle. The mixture was ground until a homogenous solution was achieved and transferred into 15 mL centrifuge tubes. The tubes were centrifuged at 3018.6×g (5000 rpm) for 20 min at 4° C. and the supernatant was saved, and ethanol was evaporated. The residue was then mixed with 5 mL DI water, and 2 mL aliquot was taken and mixed well with 0.5 mL Folin-Ciocalteu reagent and 2 mL of 20% sodium bicarbonate solution was added. After 30 min, the absorbance was noted at 765 nm in a spectrophotometer (Nanodrop oneC, Thermofisher scientific, Waltham, Mass., USA).

Tannins

For quantification of tannins, vanillin reagent was used (Bharudin et al., 2013; Broadhurst & Jones, 1978). For preparation of vanillin hydrochloride reagent, equal volumes of 8% hydrochloric acid in methanol and 4% vanillin in ethanol were mixed before the experiment. The extract was prepared by grinding the sample in ethanol, occasionally swirling it for 4-5 h and ultimately centrifuging at 3018.6×g for 20 min. One milliliter of the supernatant of each sample was then pipetted and dispensed in a scintillation vial, 5 mL of the reagent was then added, and the sample was analyzed using a spectrophotometer (Nanodrop oneC, Thermofisher scientific, Waltham, Mass., USA) at 500 nm. The standard graph was prepared using catechin and results for tannin were expressed as catechin equivalent.

Phytic Acid

For quantification of phytates, the original method of Wheeler & Ferrel was modified and followed (Ahmed et al., 2013; Wheeler & Ferrel, 1971). For extraction, 10 g of sample was ground in a mortar pestle and added into a 125 mL Erlenmeyer flask containing 50 mL acetic acid. The mixture was kept on a magnetic stirrer plate for 45 min. Then, a 10 mL aliquot of the supernatant was transferred into a scintillation vial, 4 mL of ferric chloride was added, and the contents were heated in a boiling water bath for 45 min. Additionally, 1 mL of 30% sodium sulphate was added to each vial. The precipitates were collected on Whatman filter paper 40 using a funnel. The precipitates were then washed with 25 mL acetic acid and water and dispersed in 40 mL 3.2 N nitric acid in a 100 mL volumetric flask. The volume was then made to 100 mL using water. 5 mL aliquot of the mixture was taken and was diluted with 70 mL water, 20 mL of 1.5 M KSCN was then added giving a brown color. The absorbance was noted using a Nanodrop spectrophotometer (Thermofisher scientific, Waltham, Mass., USA) at 480 nm. The standard curve was prepared using iron nitrate solution. The calculations were done based on equation 21, considering a constant 4 Fe: 6 P ratio in the precipitates.

$$Phytate P mg / ( 100 g sample ) = \frac{Fe ( µg ) \times 15}{weight of the sample ( g )} \qquad ( 21 )$$

Protein Content and Amino Acid Analysis

Protein and Amino acid analysis were conducted using Kjeldahl, AOAC Official method 984.13 (A-D), 2006 and AOAC Official method 982.30 E (a, b, c), 2006 respectively. The analysis was conducted by Agriculture Experiment Station Chemical Laboratories, University of Missouri, Columbia.

Mineral Analysis

Mineral analysis of fermented kodo and proso millet sample was conducted. The analysis of samples was done using Inductively Coupled Plasma-Optical Emission Spectroscopy (ICP-OES) at the Soil and Plant Testing Laboratory, University of Missouri.

Software for Statistical Analysis

The experiments were replicated three times and statistical analysis was done using JMP software (Cary, N.C., USA). For pH, water activity, moisture content, a full factorial design was used, and for total phenol content, tannins, phytic acid, one-way ANOVA was used (P=0.05). For the post-hoc test, the Tukey test was used.

### Results and Discussion

pH

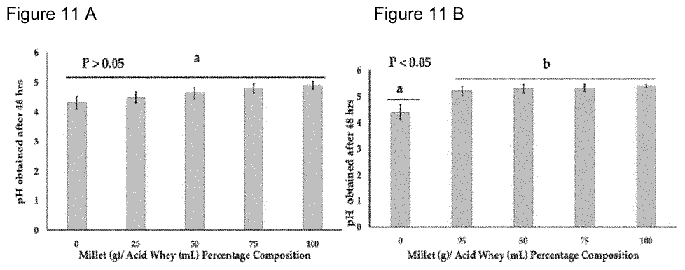

The pH of the food product explains the presence of the free hydrogen ion. The acids present in the food product releases these free hydrogen ions giving the food product a sour taste. The pH of the food product increases as there is decrease in the presence of hydrogen ions wherein if the pH value is less than 7, the food is considered acidic and more than 7 alkaline. Low (4.6-6.9) and high pH (>7) prevents the microbial growth which can prolong the shelf life of the product and hence the pH of a product varies with the kind of processing involved. As shown in FIG. 11, acid whey sample had the lowest initial pH of 4.26 and the millet-only sample mixed with water had the pH values of 6.82 and 6.90 for kodo and proso millet, respectively. After 24 hr, the pH obtained for the millet grain powder combined with water at 50% w/v was observed to be 5.99 for kodo and 6.28 for proso. For the similar percentage composition with millet powder and acid whey, the pH was observed to be 4.64 for kodo and 4.99 for proso after 24 hr of being mixed.

The decreased pH of the matrix is because of the predominant presence of acid whey. The acid whey also has the potential to carry out fermentation because of the Lactic acid bacteria which leads to formation of organic acids, such as lactic and acetic acids. Lactic acid bacteria have a high acid tolerance and has ability to survive pH condition 5 or below as it ferment sugars such as lactose, maltose, glucose etc., via homo-hetero or mixed acid fermentation. Overall, for the matrix, increase in the pH was observed after mixing the acid whey and millets. The sample pHs were proportional to the amount of millet added. For example, both kodo and proso millet, a trend was observed wherein, as the amount of millet sample was increased, the pH increased. The highest pH was observed for composition containing highest amount of millet, i.e., 100% millet-acid whey matrix, followed by the 75%, 50% and 25% millet-acid whey samples. The pH values for the composition and time for both kodo and proso were found to be significantly different (p≤0.05).

Millets are considered to be of alkaline nature as they are considered one of the rich sources of minerals, such as magnesium, calcium, sodium, potassium, zinc and iron. The mineral content in millets has found to range from 1.7 to 4.3 g/100 g. This observation can be attributed to the fact that anti-nutritional factors, such as phytic acid and tannins, are responsible for binding minerals and making them not readily available and fermentation can enable its bioavailability.

Water Activity and Moisture Content

Water activity is an important property which can predict the stability and safety of a food product in terms of microbial growth and chemical deteriorative reactions. It represents the ratio of the vapor pressure of the food to the vapor pressure of distilled water. If the water activity of a food product is greater than 0.95, it explains that there is sufficient moisture available for supporting growth of bacteria, yeast and mold. Reduced water activity inhibits the growth of microorganisms. Similarly, moisture content explains the amount of water present in the food product. It affects the taste, appearance, and weight of the food product. There are more chances of growth of microorganism as the water content increases in a food product. Excessive moisture content can lead to agglomeration and a too dry sample can affect the consistency of the product. Hence, it is termed as a quality factor. Data for the moisture content and water activity is found in Table 12.

TABLE 12
Water activity (dry sample) and moisture content of 0, 50 and 100%
w/v kodo and proso millet composition after 48 hr. of mixing.

| Sample ID | Water Activity (dry) | Moisture Content |
|---|---|---|
| AW | 0.974 ± 0.004^{a} | 92.74 ± 0.519^{a} |
| Pure Kodo | 0.227 ± 0.002^{b} | 9.95 ± 0.214^{b} |
| KAW (50) | 0.260 ± 0.007^{b} | 56.93 ± 0.965^{c} |
| KAW (100) | 0.265 ± 0.024^{b} | 47.17 ± 0.254^{c} |
| Pure Proso | 0.256 ± 0.009^{b} | 8.77 ± 0.09^{b} |
| PAW (50) | 0.129 ± 0.007^{c} | 51.48 ± 0.5^{c} |
| PAW (100) | 0.155 ± 0.013^{c} | 47.04 ± 0.278^{c} |

*Each value is the mean of measurements taken 3 times ± standard deviation. Different superscripts indicate significantly different values (p < 0.05) in the same column.

The 0% sample composed of just acid whey had a very minor change in water activity of 0.973 in the beginning and 0.974 after 48 h which is similar to any food beverage. The water activity of cereal grains is usually around 0.400-0.700 which is considered to be microbiologically safe as water activity below 0.85 or less does not support pathogenic bacteria such as Salmonella, Escherichia coli and Bacillus cereus. While optimizing the water activity after drying the sample in the oven, it was observed that the fermented millet samples had a higher water activity than the pure millet samples because of mixing with liquid acid whey which got held tightly to the grains as adsorbed water. This phenomenon was observed for both kodo and proso millets wherein the water activity on dry basis for pure kodo sample was 0.230 which increased to 0.260 and 0.265 for KAW (50) sample, and KAW (100) sample, respectively. Similarly, for the proso millet sample, the water activity for pure proso sample was 0.056 which increased 0.130 and 0.160 for the PAW (50) and PAW (100) sample, respectively. According to statistical analysis, the values were not significantly different (P>0.05) for proso and kodo matrix, respectively.

Millets are low moisture containing food products with average amount to be 10-30 g water per 100 g of grain. The moisture content of the sample matrix decreased as the millet amount in the slurry significantly increased. The maximum moisture was observed for the acid whey sample viz., 92.7% wet basis. According to Tukey's post-hoc test, which was conducted to find which of the composition would be most suitable for a probiotic beverage indicated that all the values were significantly different for all the composition points (P>0.05).

Total Phenol Content

Millets contain phenolic acids and flavonoids in different part of the plants in both free and conjugated forms. The content of phenolic compounds varies with the type of millet grain. The hydroxybenzoic acids in millets include protocatechuic, p-hydroxybenzoic, gallic, vanillic, syringic etc. Kodo millets are said to have the maximum level hydroxybenzoic acids, specifically concentrated in the soluble phenolic fraction of the whole millet grain. The high amounts of phenolics enables the millet grain to have antioxidant properties which they gain through the property of free radical scavenging.

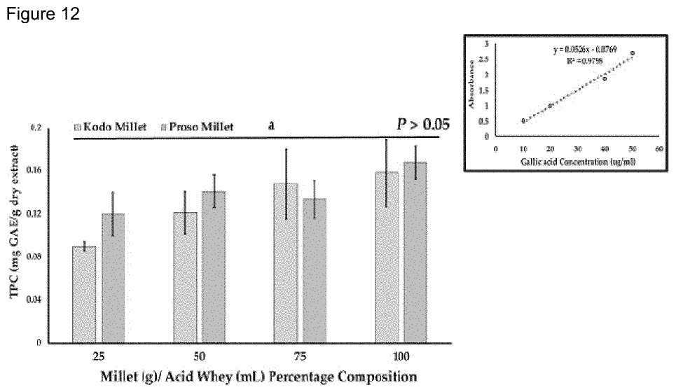

The calculation of the total phenol content (TPC) as shown in FIG. 12 For both the millets showed that the total phenol content significantly increased (P>0.05) as the amount of millets increased in the matrix from 25% w/v to 100% w/v. Samples KAW (100) and PAW (100) were found to have the maximum total phenol content of 0.157 and 0.168 mg GAE/g dry extract, respectively. The results obtained were similar to the outcomes of the study conducted by the study investigated various milling blends of the multigrain flour fermented with different commercial starter cultures. It was found that there was an increase in folate, total phenol level and 2,2-diphenyl-1-picrylhydrazyl radical scavenging activity (DPPH-RSA) in the multigrain flour with addition of rye and hulled oat. The reason sighted for this increase were the LAB bacteria which lead to accumulation of bioactive compounds wherein the LAB metabolic product increases the level of extractable bioactive compounds.

While comparing kodo and proso millets, the total phenol was found to be not statistically significant (P>0.05). The objective of using different millet compositions in acid whey was to investigate the optimum amounts of millets in the matrix that can be effectively fermented using acid whey. The results showed that acid whey efficiently fermented the millets even at 100% w/v (KAW (100) & PAW (100)) composition wherein the amount of millet was equivalent to acid whey.

Tannins

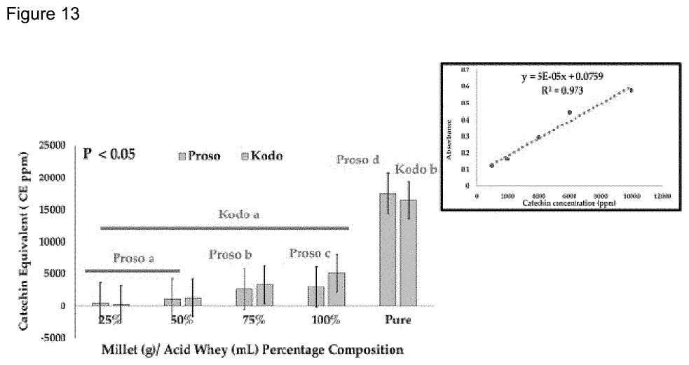

Tannins are polymerized flavanol units found in cereal grains which tend to bind with proteins, carbohydrates and minerals, decreasing the digestibility of the nutrients. A decrease in the amount of tannins was observed as shown in FIG. 13 after fermentation for both kodo and proso millets wherein the pure kodo and proso powdered sample had an initial tannin amount of 16.45 g/L and 17.50 g/L, respectively, which decreased to 5.07 g/L and 3.01 g/L, respectively, for the 100% w/v sample. Hence, the percentage decrease was found to be 69.17% for the kodo sample and 82.8% for the proso sample. Following a similar trend, for the 25% w/v sample (KAW (25) and PAW (25), the tannin content was further decreased by 96.7% and 98.1% for kodo and proso, respectively, giving a significant difference (P<0.05). Reducing phytate and tannin contents tend to increase in the extractability of minerals.

Phytic Acid

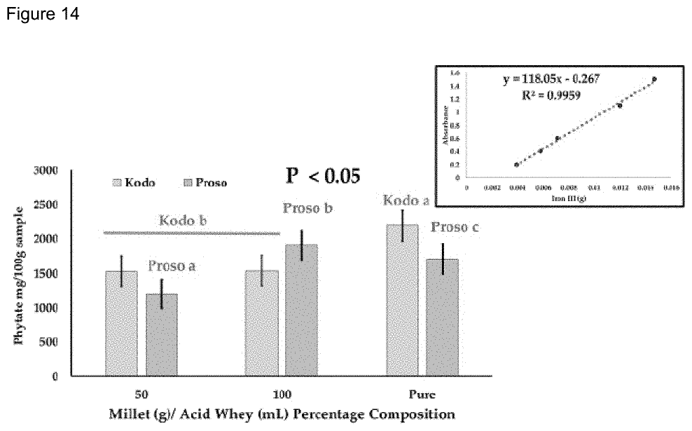

Phytic acid is myoinositol 1,2,3,4,5,6-hexakis dihydrogen phosphate. Its metabolism plays several roles in eukaryotic cells such as phosphorous and minerals storage, homeostasis in germinating seeds and antioxidant activity. It is generally regarded as anti-nutritional factor because of its ability to bind minerals and alter their bioavailability as it is an effective chelator of cations. It reacts with proteins to form complexes making it less soluble and interfering with enzymatic degradation and digestion of peptides. For kodo millet, a decrease in phytate amount was observed as the fermentation was performed as shown in FIG. 14. The pure kodo sample had the maximum phytate amount of 2192 mg/100 g sample which decreased to 1900 mg/100 g sample for the 100% w/v fermented (KAW (100) sample accounting to a decrease of 9.21%. For the KAW (50) sample, a further decrease of 47.2% was observed. For proso millet, the fermented millet was found to have more phytate content which is not consistent with previously conducted studies as fermentation leads to increase in activity of phytase which further leads to degradation of phytates.

Protein Content and Amino Acid Analysis

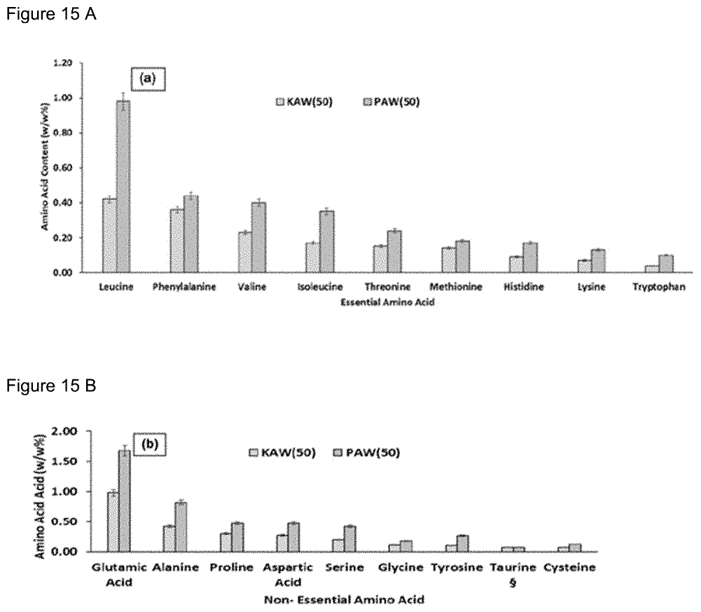

Proso millet is rich in protein content and essential amino acid such as leucine, isoleucine and methionine. Kodo millet is also considered to be rich in protein content when compared with rice. Similarly, acid whey consists of crude protein in the range of 1.71-3.71 mg/g consisting of α-Lactalbumin, β-Lactoglobulin, bovine serum albumin, lactoferrin, lactoperoxidase, and immunoglobulins even though there is substantial depletion because of extensive heat treatment in the production of yogurt. It was found that a food product created using both the acid whey and millet component will have sufficient amount of protein and a rich amino acid profile. The protein content of the PAW (50) was obtained to 7.89 w/w % as compared to 4.55 w/w % in KAW (50). In terms of essential amino, as shown in FIG. 15, leucine was observed to be in greater quantities as compared to other essential amino acid and in non-essential amino acid, glutamic acid was found in abundance. Leucine helps in healing skin and bones in body, leads to muscle growth and controls sugar level in blood. Likewise, glutamic acid increases immunity and improves the intestinal health.

Mineral Analysis

The ICP-OES analysis was conducted on the samples because of their high total solids. The analysis indicated that the millet acid whey matrix after being mixed for 24 hr. observed an increase in the amount of Potassium and Calcium as shown in Table 13.

TABLE 13
Mineral contents of different sample compositions for kodo and proso millets.

| | N | P | K | Ca | Mg | Zn | Fe | Mn | Cu |
|---|---|---|---|---|---|---|---|---|---|
| Composition | (%) | (%) | (%) | (%) | (%) | (ppm) | (ppm) | (ppm) | (ppm) |
| Acid Whey | 0.07 | 0.086 | 0.157 | 0.143 | 0.008 | 4.37 | 0.311 | 0.008 | 0.046 |
| Prue Kodo | 1.58 | 0.20 | 0.19 | 0.03 | 0.12 | 23.82 | 48.16 | 14.38 | 10.54 |
| KAW (50) | 1.46 | 0.27 | 0.36 | 0.27 | 0.09 | 27.19 | 41.32 | 9.87 | 10.18 |
| KAW (100) | 1.54 | 0.24 | 0.25 | 0.18 | 0.10 | 28.59 | 49.62 | 12.30 | 8.77 |
| Pure Proso | 2.77 | 0.35 | 0.29 | 0.03 | 0.17 | 34.28 | 46.66 | 12.29 | 9.24 |
| PAW (50) | 2.73 | 0.38 | 0.41 | 0.24 | 0.13 | 33.30 | 50.24 | 8.69 | 6.89 |
| PAW (100) | 2.79 | 0.37 | 0.30 | 0.16 | 0.15 | 32.64 | 33.44 | 9.98 | 7.56 |

The increase in mineral content of the acid whey-millet matrix when compared to the pure millet indicates the effectiveness of the process of fermentation. Minerals from cereals and legume sources generally have low bioavailability because of the complex system of non-digestible material that they are combined with and hence, the digestive enzymes are not able to access them. Fermentation helps in the increasing the bioavailability of the minerals by reducing antinutritional factors such as phytic acid and tannins which binds to these minerals by loosening the complex matrix.

### Conclusions

The acid whey was able to ferment the millets when they were submerged in it without addition of any external cultures. The pH analysis results showed that there was decrease in the pH of millet but overall increase in pH of the matrix because of neutralization of lactic acid of acid whey and minerals present in the millets. Further microbiological analysis should be conducted for confirmation of the strains enabling the fermentation process in the matrix and qualifying to be of genus Lactobacillus. The confirmatory test can include enumeration, grams assays, catalase test and genetic identification test based on polymerase chain reaction. Fermentation led to increase in the total phenol content indicating unbinding of the bioactive compounds from the complex components of the matrix. It also led to a decrease in antinutritional factors, such as tannins and phytic acid. There was about 69.17% and 82.8% decrease observed for tannins for kodo and proso millet grain respectively. For phytic acid, the decrease for kodo millet was found to be 9.21%. The possible reason for this decrease is because lactic acid bacteria in the acid whey act as a source of enzymes phytase and tannase. The reduction of antinutritional factors indicated the increased bioavailability of nutrients that earlier formed complexes with phytic acid and tannins. Hence, the mixture can be utilized as a nutritious food product and possibly part of a weaning formulation as well. Different compositions were studied to find the optimum amount of millet for fermentation with acid whey. KAW (50) and PAW (50) were found to have a moderate impact in terms of polyphenolic activity and antinutritional factors showing properties of both acid whey and millet without one component dominating the other. To validate the results, further studies can be conducted such as metabolomic analysis. Metabolomic analysis can provide understandings of the biochemistry reinforcing the reaction when altercation of the matrix occurs once acid whey is mixed with millet. Utilization of acid whey in the millet matrix and its value-added properties, suggested how environmental pollution caused by the improper disposal methods of acid whey can be transformed into a high value upcycled nutritious food.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for forming an acid whey-based food product, the method comprising:
(a) preparing a matrix suitable for spray drying, wherein the matrix is a homogenous mixture comprising acid whey and flour; and
(b) spray drying the matrix to form a powder of dried matrix;
thereby forming the acid whey-based food product.

2. The method of claim 1, wherein the flour is selected from the group consisting of amaranth, wheat, rice, sorghum, buckwheat, millets, teff, fonio, and combinations thereof and combinations thereof.

3. The method of claim 2, wherein the millets are selected from the group finger millet, little millet, barnyard millet, kodo millet, proso millet, pearl millet, foxtail millet, and combinations thereof.

4. The method of claim 1, wherein the matrix has a concentration in a range of about 10% (m/v) to about 100% (m/v) based on the mass of the flour in grams per volume of acid whey in milliliters.

5. The method of claim 1, wherein the matrix has a concentration in a range of about 50% (m/v) to about 100% (m/v) based on the mass of the flour in grams per volume of acid whey in milliliters.

6. The method of claim 1, wherein the matrix is fermented in a range from greater than 0 hours to about 48 hours before the spray drying.

7. The method of claim 1, wherein the matrix further comprises an animal milk.

8. The method of claim 7, wherein the animal milk is selected from the group consisting of cow milk, sheep milk, goat milk, donkey milk, camel milk, and combinations thereof.

9. The method of claim 7, wherein the animal milk is at a concentration of about 10% (m/v) to about 90% (m/v) of the matrix.

10. The method of claim 1, wherein the matrix further comprises a plant-based m ilk/beverage.

11. The method of claim 10, wherein the plant-based milk/beverage is selected from the group consisting of soy milk, almond milk, oat milk, millet milk, and combinations thereof.

12. The method of claim 10, wherein the plant-based milk/beverage is at a concentration of about 10% (m/v) to about 90% (m/v) of the matrix.

13. An acid whey-based food product that is a powder comprising particles, wherein each particle comprises homogeneous mixture of dried acid whey and flour.

14. The acid whey-based food product of claim 13, which is free flowing quantified as having a Carr Index in a range of about 2 to about 20 and a Hausner ratio in a range of about 1 to about 1.5.

15. The acid whey-based food product of claim 13 having a dispersibility percentage in a range of about 80% to about 90%.

16. The acid whey-based food product of claim 13 having:
(a) a color, quantified according to the Commission Internationale d'Eclairage (CIE) L*a*b system, of L in a range of about 70 to about 98, *a in a range of about −1 to about 1.5, and *b in a range of about 0.9 to about 20;
(b) a Chroma in a range of about 1 to about 10; and
(c) a Hue in a range of about 0.9 to about 97.

17. The acid whey-based food product of claim 13 having a water activity (Aw) in a range of about 0.2 to about 0.9.

18. The acid whey-based food product of claim 13 having a moisture content in a range of about 3% to about 10%.

19. The acid whey-based food product of claim 13 having a refractive index in a range of about 1 to about 2.

20. The acid whey-based food product of claim 13 having a water solubility index (WSI) in a range of about 70% to about 90%.

21. The acid whey-based food product of claim 13 having a water absorption index (WAI) in a range of about 10 to about 25.

22. The acid whey-based food product of claim 13 having a particle size in terms of cumulant diameter in a range of about 1 μm to about 20 μm.

23. The acid whey-based food product of claim 13 having a zeta potential in a range of about ±10 mV to about ±30 mV.

24. The acid whey-based food product of claim 13 having a total phenol content (TPC) of about 3 mg GAE/g dry extract to about 6 mg GAE/g dry extract.

25. The acid whey-based food product of claim 13 having a tannin amount quantified as catechin equivalent (CE) in a range of about 250 ppm to about 18,000 ppm.

26. The acid whey-based food product of claim 13 having a phytic acid amount quantified as a maximum phytate amount in a range of about 1,000 mg/100 g sample to about 2,000 mg/100 g sample.
